(19) United States
(12) Patent Application Publication
(10) Pub. No.: US 2026/0046162 A1
(43) Pub. Date: Feb. 12, 2026

(54) METHOD, DEVICE, APPARATUS, AND STORAGE MEDIUM FOR COMMUNICATION

(71) Applicant: Nokia Solutions and Networks Oy, Espoo (FI)

(72) Inventors: Jun GAO, Shanghai (CN); Cheng An ZHANG, Shanghai (CN); Dong HUANG, Shanghai (CN)

(73) Assignee: Nokia Solutions and Networks Oy, Espoo (FI)

(21) Appl. No.: 19/290,525

(22) Filed: Aug. 5, 2025

(30) Foreign Application Priority Data
Aug. 9, 2024 (CN) 202411099990.9

(51) Int. Cl. H04L 12/28; H04B 7/24

(52) U.S. Cl. CPC H04L 12/2801; H04B 7/24

(57) ABSTRACT

A method for communication includes performing at a terminal device, matching between a first communication capability of the terminal device and a second communication capability of a network device, the first and second communication capabilities indicating first and second wired and wireless communication capabilities, respectively; transmitting a matching result for to the network device, the matching result indicating whether the first communication capability successfully matches or fails to match the second communication capability; receiving, from the network device, configuration information for a wired communication connection between the terminal device and the network device based on the matching result indicating that the first communication capability successfully matches the second communication capability; and performing communication with the network device via the wired communication connection based on the configuration information.

### FIELD

Example embodiments of the present disclosure relate to the field of communications technologies, and more particularly, to methods, devices, apparatuses, and computer-readable storage media for communication.

### BACKGROUND

Terminal devices and network devices usually communicate via wireless communication protocols. Compared with wireless communication, wired communication has high transmission quality, better confidentiality, and signals are not easily interfered with or intercepted. Data Over Cable Service Interface Specification (DOCSIS) standard is an international standard established by wired cable standards organizations,
and it is currently an industry standard for providing high-quality Internet access over hybrid fiber coax (HFC) networks.

However, the communication capacity of DOCSIS is limited. Therefore, it is desirable to enable communication of larger channel capacity by multiplexing existing wired communication infrastructure, such as HFC connections.

### SUMMARY

In a first aspect of the present disclosure, a terminal device is provided. The terminal device includes: at least one processor; and at least one memory coupled to the at least one processor. The at least one memory having instructions stored thereon, the at least one memory and the instructions are configured, with the at least one processor, to cause the terminal device to: perform matching between a first communication capability of the terminal device and a second communication capability of a network device, the first communication capability indicating at least one of a first wired communication capability or a first wireless communication capability of the terminal device, and the second communication capability indicating at least one of a second wired communication capability or a second wireless communication capability of the network device; transmit a matching result for the first communication capability and the second communication capability to the network device, the matching result indicating whether the first communication capability successfully matches or fails to match the second communication capability; receive, from the network device, configuration information for a wired communication connection between the terminal device and the network device based on the matching result indicating that the first communication capability successfully matches the second communication capability; and perform communication with the network device via the wired communication connection based on the configuration information.

In a second aspect of the present disclosure, a network device is provided. The network device includes: at least one processor; and at least one memory coupled to the at least one processor. The at least one memory having instructions stored thereon, the at least one memory and the instructions are configured, with the at least one processor, to cause the network device to: perform matching between a first communication capability of a terminal device and a second communication capability of the network device, the first communication capability indicating at least one of a first wired communication capability or a first wireless communication capability of the terminal device, and the second communication capability indicating at least one of a second wired communication capability or a second wireless communication capability of the network device; receive, from the terminal device, a matching result for the first communication capability and the second communication capability, the matching result indicating whether the first communication capability successfully matches or fails to match the second communication capability; transmit, to the terminal device, configuration information for a wired communication connection between the terminal device and the network device based on the matching result indicating that the first communication capability successfully matches the second communication capability; and perform communication with the terminal device via the wired communication connection based on the configuration information.

In a third aspect of the present disclosure, a terminal device is provided. The terminal device is connected to a network device through a physical transmission medium, and includes a first logical plane configured to connect between a physical plane and a component in the terminal device supporting a first wireless communication capability, the physical plane being configured to characterize a wired communication connection based on the physical transmission medium between the terminal device and the network device; a first analogue front end, AFE, connected to the first logical plane and the physical transmission medium, respectively; and a controller configured to control the terminal device to perform wired communication with the network device via the physical transmission medium based on configuration information for the wired communication connection.

In a fourth aspect of the present disclosure, a method for communication is provided. The method includes: performing at a terminal device, matching between a first communication capability of the terminal device and a second communication capability of a network device, the first communication capability indicating at least one of a first wired communication capability or a first wireless communication capability of the terminal device, and the second communication capability indicating at least one of a second wired communication capability or a second wireless communication capability of the network device; transmitting a matching result for the first communication capability and the second communication capability to the network device, the matching result indicating whether the first communication capability successfully matches or fails to match the second communication capability; receiving, from the network device, configuration information for a wired communication connection between the terminal device and the network device based on the matching result indicating that the first communication capability successfully matches the second communication capability; and performing communication with the network device via the wired communication connection based on the configuration information.

In a fifth aspect of the present disclosure, a method for communication is provided. The method includes: performing, at a network device, matching between a first communication capability of a terminal device and a second communication capability of the network device, the first communication capability indicating at least one of a first wired communication capability or a first wireless communication capability of the terminal device, and the second communication capability indicating at least one of a second wired communication capability or a second wireless communication capability of the network device; receiving, from the terminal device, a matching result for the first communication capability and the second communication capability, the matching result indicating whether the first communication capability successfully matches or fails to match the second communication capability; transmitting, to the terminal device, configuration information for a wired communication connection between the terminal device and the network device based on the matching result indicating that the first communication capability successfully matches the second communication capability; and performing communication with the terminal device via the wired communication connection based on the configuration information.

In a sixth aspect of the present disclosure, an apparatus for communication is provided. The apparatus includes: means for performing matching between a first communication capability of the terminal device and a second communication capability of a network device, the first communication capability indicating at least one of a first wired communication capability or a first wireless communication capability of the terminal device, and the second communication capability indicating at least one of a second wired communication capability or a second wireless communication capability of the network device; means for transmitting a matching result for the first communication capability and the second communication capability to the network device, the matching result indicating whether the first communication capability successfully matches or fails to match the second communication capability; means for receiving, from the network device, configuration information for a wired communication connection between the terminal device and the network device based on the matching result indicating that the first communication capability successfully matches the second communication capability; and means for performing communication with the network device via the wired communication connection based on the configuration information.

In a seventh aspect of the present disclosure, an apparatus for communication is provided. The apparatus includes: means for performing matching between a first communication capability of a terminal device and a second communication capability of the network device, the first communication capability indicating at least one of a first wired communication capability or a first wireless communication capability of the terminal device, and the second communication capability indicating at least one of a second wired communication capability or a second wireless communication capability of the network device; means for receiving, from the terminal device, a matching result for the first communication capability and the second communication capability, the matching result indicating whether the first communication capability successfully matches or fails to match the second communication capability; means for transmitting, to the terminal device, configuration information for a wired communication connection between the terminal device and the network device based on the matching result indicating that the first communication capability successfully matches the second communication capability; and means for performing communication with the terminal device via the wired communication connection based on the configuration information.

In an eighth aspect of the present disclosure, there is provided a computer-readable storage medium having a computer program stored thereon. The computer program including instructions that, when executed by a processor of a device, causing the device to perform the method according to the fourth aspect or the fifth aspect.

It should be understood that the content described in the summary section is not intended to limit the key or important features of the embodiments of the present disclosure, nor is it intended to limit the scope of the present disclosure. Other features of the present disclosure will become readily understood from the following description.

### BRIEF DESCRIPTION OF DRAWINGS

Example embodiments of the present disclosure are presented by way of example, and their advantages are explained in greater detail below with reference to the accompanying drawings, in which:

FIG. 1 illustrates a schematic diagram of an environment in which example embodiments described herein may be implemented;

FIG. 2 illustrates a schematic diagram of a communication signaling chart according to some example embodiments of the present disclosure;

FIG. 3 illustrates a schematic diagram of an example system architecture for implementing communication according to some example embodiments of the present disclosure;

FIG. 4 illustrates a schematic diagram of a partial example architecture for the system architecture in FIG. 3 according to some example embodiments of the present disclosure;

FIG. 5 illustrates a schematic diagram of a partial example architecture for the system architecture in FIG. 3 according to some example embodiments of the present disclosure;

FIG. 6 illustrates a schematic diagram of an example architecture for offline radio frequency calibration according to some example embodiments of the present disclosure;

FIG. 7A illustrates a schematic diagram of an example of frequency configuration at a terminal receiving end according to some example embodiments of the present disclosure;

FIG. 7B illustrates a schematic diagram of an example of frequency configuration at a terminal transmit end according to some example embodiments of the present disclosure;

FIG. 8 is a flowchart of a method for communication at a terminal device according to some example embodiments of the present disclosure;

FIG. 9 illustrates a flowchart of a method for communication at a network device according to some example embodiments of the present disclosure;

FIG. 10 illustrates a simplified block diagram of a device suitable for implementing example embodiments of the present disclosure; and

FIG. 11 illustrates a schematic diagram of a computer-readable medium according to some example embodiments of the present disclosure.

In all figures, the same or similar reference numbers refer to the same or similar elements.

### DETAILED DESCRIPTION

The principles and spirit of the present disclosure will be described below with reference to several example embodiments shown in the accompanying drawings. It should be understood that these specific example embodiments are described merely to enable those skilled in the art to better understand and implement the present disclosure, and do not limit the scope of the present disclosure in any way.

As used herein, the term “comprising” and the like should be understood to be open-ended, i.e., “including but not limited to”. The term “based on” should be understood as “based at least in part on”. The terms “one embodiment” or “the embodiment” should be understood as “at least one embodiment”. The terms “first,” “second,” and the like may refer to different or identical objects. Other explicit and implicit definitions may also be included below.

As used herein, the term “determining” encompasses a wide variety of actions. For example, “determining” may include computing, calculating, processing, deriving, investigating, looking up (e.g., looking up in a table, database, or another data structure), ascertaining, etc. Further, “determining” may include receiving (e.g., receiving information), accessing (e.g., accessing data in memory), and/or the like. Further, “determining” may include parsing, selecting, selecting, establishing, etc.

Herein, unless explicitly stated, “responding to A” performs one step and does not imply that this step is performed immediately after “A”, but may include one or more intermediate steps.

The term “circuit device” as used herein refers to one or more of: (a) hardware only circuit implementations, such as implementations of analog and/or digital circuitry only; and (b) a combination of hardware circuitry and software, such as (if applicable): (i) a combination of analog and/or digital hardware circuitry and software/firmware, and (ii) any portion of a hardware processor with software (including digital signal processors, software, and memory that work together to cause devices such as optical communication devices or other computing devices to perform various functions); and (c) hardware circuitry and/or a processor, such as a microprocessor or a portion of a microprocessor, that requires software (e.g., firmware) for operation, but may not have software when software is not required for operation.

The definition of the circuit arrangement applies to all use scenarios of this term in the present application, including any claims. As another example, the term “circuit device” as used herein also covers only a hardware circuit or processor (or multiple processors), or a portion of a hardware circuit or processor, or an implementation of its accompanying software or firmware. For example, if applicable to a particular claim element, the term “circuitry” also covers similar integrated circuits in a baseband integrated circuit or processor integrated circuit or OLT or other computing device.

As used herein, the term “communication network” refers to a network that follows any suitable communication standard, such as New Radio (NR), Long Term Evolution (LTE), LTE-Advanced (LTE-A), Wideband Code Division Multiple Access (WCDMA), High Speed Packet Access (HSPA), Narrowband Internet of Things (NB-IoT), and the like. Further, communication between the terminal device and the network devices in the communication network may be performed according to any suitable generation of communication protocols including, but not limited to, first generation (1G), second generation (2G), 2.5G, 2.75G, third generation (3G), fourth generation (4G), 4.5G, fifth generation (5G), sixth generation (6G) communication protocol, and/or any other protocol currently known or to be developed in the future. Example embodiments of the present disclosure may be applied to various communication systems, including, but not limited to, terrestrial communication systems, non-terrestrial communication systems, or combinations thereof. Considering the rapid development in the communication field, it is of course also possible that future types of communication technologies and systems can be used to implement the present disclosure. It is not to be construed as limiting the scope of the present disclosure to just the foregoing systems.

As used herein, the term “network device” refers to a node in a communication network via which a terminal device accesses a network and receives service therefrom. Depending on the terminology and technology applied, a network device may refer to a base station (BS) or an access point (AP), such as a NodeB (NodeB or NB), an evolved NodeB (eNodeB or eNB), an NR NB (also referred to as a gNB), a remote radio unit (RRU), a radio head (RH), a remote radio head (RRH), a relay, an integrated access and backhaul (IAB) node, a low-power node such as a femto, pico, or the like.

As used herein, the term “terminal device” refers to any terminal device capable of wireless communication. By way of example and not limitation, a terminal device may also be referred to as a network device, a user equipment (UE), a subscriber station (SS), a portable subscriber station, a mobile station (MS), or an access terminal (AT). A terminal device may include, but is not limited to, a mobile phone, a cellular phone, a smart phone, a voice-over-IP (VoIP) phone, a wireless local loop phone, a tablet computer, a wearable terminal device, a personal digital assistant (PDA), a portable computer, a desktop computer, an image capture terminal device such as, for example, a digital camera, a gaming terminal device, a music storage and playback device, a vehicle mounted wireless terminal device, a wireless endpoint, a mobile station, a laptop embedded device (LEE), a laptop mounted device (LME), a universal serial bus (USB) dongle, a smart device, a wireless customer premises equipment (CPE), an Internet of Things (IoT) device, a watch or other wearable device, a head-mounted display (HMD), a vehicle, a drone, a medical device and an application (e.g., a remote procedure), an industrial device and an application (e.g., a robot and/or other wireless device operating in an industrial and/or automated processing chain environment), a consumer electronic device, a device running on a commercial and/or industrial wireless network, etc. The terminal device may correspond to a mobile terminal (MT) portion (e.g., a relay node) of the IAB node. In the following description, the terms “terminal device”, “network device”, “terminal”, “user equipment”, and “UE” may be used interchangeably.

As used herein, the term “circuit” refers to one or more of:
(a) only hardware circuit implementations, such as implementations of analog and/or digital circuitry only; and
(b) a combination of hardware circuitry and software, such as if applicable:
(i) analog and/or digital hardware circuitry in combination with software/firmware, and
(ii) any part of a hardware processor is associated with software (including digital signal processors, software, and memory working together to cause devices such as OLTs or other computing devices to perform various functions); and
(c) Hardware circuits and/or processors, such as a microprocessor or part of a microprocessor, require software (e.g., firmware) for operation, but may not have software when software is not required for operation.

The definition of the circuit applies to all usage scenarios of this term in this application, including any claims. As another example, the term “circuit” as used herein also covers only a hardware circuit or processor (or multiple processors), or a portion of a hardware circuit or processor, or an implementation of its accompanying software or firmware. For example, if applicable to a particular claim element, the term “circuit” also covers similar integrated circuits in a baseband integrated circuit or processor integrated circuit or OLT or other computing device.

As mentioned above, industry standards have been proposed that provide high quality Internet access over hybrid fiber coax (HFC) networks. With HFC networks, wired high-speed data can now achieve higher download speeds (e.g., up to 10 Gbps), enabling a wide variety of online experiences and tools that have become part of people's daily lives, such as 4K video streaming, video conferencing, and multiplayer online games. It is desirable to develop techniques for providing cellular communications using wired network infrastructure.

There are two possible solutions that may provide more communication capacity:

1) Upgrade the wired network to a Fiber To The Home (FTTH) network.

However, this may lead to a huge waste of existed wired network infrastructure, and the construction of large-scale fiber optic networks is a huge challenge to operators.

2) Upgrade the wired network to a new New Radio over Cable (NRoC) network.

The advantage is that by designing the new gNB and CPE with an available HFC frequency range for the NRoC, the wired network may be reused.

The drawback is that since the interface between the gNB and the CPE is changed from the air interface to the wired interface, some of 3GPP specifications (such as TS38.101) may be unavailable and the chipset for the CPE may be customized, which is a big challenge for ecosystem reconstruction.

Embodiment of the present disclosure provides a solution for communication. In a solution, the terminal device performs matching between a first communication capability of the terminal device and a second communication capability of the network device, where the first communication capability indicates at least one of a first wired communication capability or a first wireless communication capability of the terminal device, and the second communication capability indicates at least one of a second wired communication capability or a second wireless communication capability of the network device; transmits a matching result for the first communication capability and the second communication capability to the network device, where the matching result indicates whether the first communication capability successfully matches or fails to match the second communication capability; receives, from the network device, configuration information for a wired communication connection between the terminal device and the network device based on the matching result indicating that the first communication capability successfully matches the second communication capability; and performs communication with the network device via the wired communication connection based on the configuration information. Therefore, the terminal device and the network device may achieve communication for the wireless communication protocol based on the wired communication connection. This not only avoids wasting the existing infrastructure of wired communication connection media, but also improves communication capacity, thus having strong applicability.

The principles and example embodiments of the present disclosure will be described in detail below with reference to the accompanying drawings.

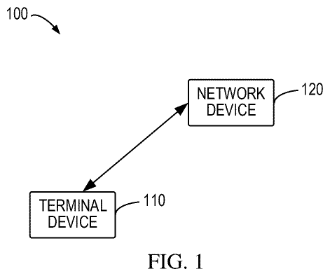

FIG. 1 illustrates a schematic diagram of an example communication network 100 in which example embodiments described herein may be implemented. The communication network 100 may be part of a communication network. The communications network 100 may include a terminal device 110 and a network device 120. The terminal device 110 may communicate with the network device 120.

In some example embodiments, the terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 130 can also support any type of interface for a user (such as a “wearable” circuit, etc.).

In some example embodiments, the network device 120 may include, for example, a wireless router configured to provide wireless network coverage to an indoor environment in which the user is located. The wireless router may be a network device conforming to 802.11 family of standards or implemented by any suitable device, such as a Wi-Fi access point (AP), the scope of which is not limited in this respect. For example, the network device 120 may communicate with another network device (for example, a base station) to provide wireless network coverage for terminal devices in a specific range, and the scope of the present disclosure is not limited in this aspect.

In some example embodiments, a link from the network device 120 to the terminal device 110 may be referred to as a downlink (DL), and a link from the terminal device 110 to the network device 120 may be referred to as an uplink (UL). In DL, the network device 120 is a transmit (TX) device (or transmitter) and the terminal device 110 is a receive (RX) device (or receiver). In UL, the terminal device 110 is a TX device (or transmitter) and the network device 120 is an RX device (or receiver).

It should be understood that the number of devices and their connections shown in FIG. 1 is merely illustrative and not limiting. Communication network 100 may include any suitable number of devices configured to implement example embodiments of the present disclosure. Although not shown, it should be understood that one or more other devices may be deployed in the communication network 100.

Communication in the communication network 100 may be implemented according to any suitable communication protocol (s). Examples of communication protocols include, but are not limited to, cellular communication protocols such as first generation (1G), second generation (2G), 2.5G, 2.75G, third generation (3G), fourth generation (4G), 4.5G, fifth generation (5G), sixth generation (6G), wireless local area network communication protocols such as Institute of Electrical and Electronics Engineers (IEEE) 802.11, and/or any other protocol currently known or to be developed in the future.

Further, the communication may utilize any suitable wireless communication technology including, but not limited to: code division multiple access (CDMA), frequency division multiple access (FDMA), time division multiple access (TDMA), frequency division duplex (FDD), time division duplex (TDD), multiple input multiple output (MIMO), orthogonal frequency division multiplexing (OFDM), discrete Fourier transform-based spread orthogonal frequency division multiplexing (DFT-s-OFDM), and/or any other technology currently known or to be developed in the future.

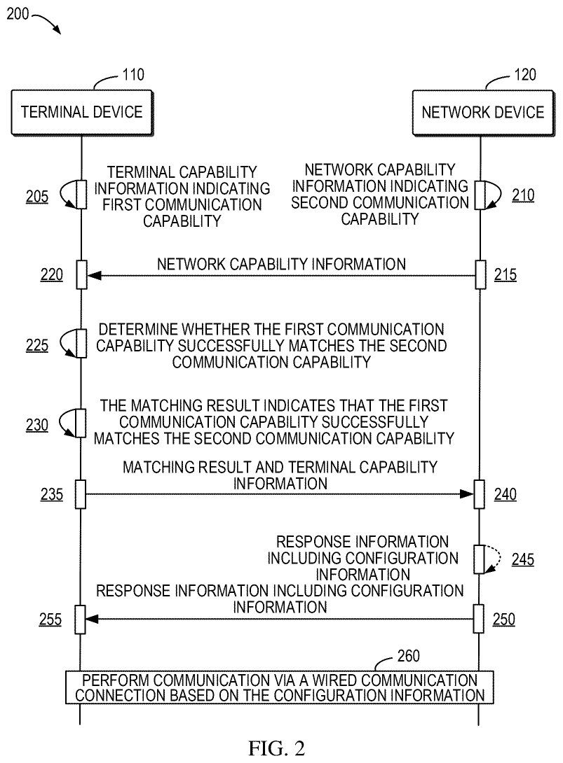

FIG. 2 illustrates a schematic diagram of a communication signaling chart 200 according to some example embodiments of the present disclosure. The signaling chart 200 may involve terminal device 110 (e.g., CPE) and the network device 120 (e.g., gNB) in FIG. 1. Although a terminal device 110 and a network device 120 are shown in FIG. 2, it should be understood that there may be a plurality of terminal devices performing similar operations of the terminal device 110 as described below, and the plurality of network devices perform similar operations of the network device 120 as described below.

It should be understood that although not shown, at least some of the actions performed at the terminal device 120 may also be performed at the network device 110 in the signaling chart 200.

In the signaling chart 200, the terminal device 110 and the network device 120 have respective communication capabilities. For example, the terminal device 110 may determine (205) the terminal capability information 205 that indicates its first communication capability. The first communication capability of the terminal device 110 indicates at least one of a first wired communication capability or a first wireless communication capability of the terminal device 110. For example, the network device 120 may determine (210) the network capability information 210 that indicates its second communication capability. The second communication capability of the network device 120 indicates at least one of a second wired communication capability or a second wireless communication capability of the network device 120. In some example embodiments, the terminal device 110 may include CPE.

For example, the first wired communication capability of the terminal device 110 and the second wired communication capability of the network device 120 may be, for example, capabilities for communicating with wired media such as optical fibers, coaxial cables, HFC, etc. The first wireless communication capability of the terminal device 110 and the second wireless communication capability of the network device 120 may be, for example, capabilities for communicating based on 3GPP protocols or other wireless communication protocols.

Furthermore, the terminal device 110 and the network device 120 perform matching on each other's communication capabilities. Specifically, the terminal device 110 may perform matching between its first communication capability and the second communication capability of the network device 120. The network device 120 may perform matching between the first communication capability of the terminal device 110 and its second communication capability.

In some example embodiments, when the network device 120 performs matching between the first communication capability of the terminal device 110 and its second communication capability, the network device 120 may transmit (215) the network capability information to the terminal device 110.

In some example embodiments, when performing the matching between the first communication capability of the terminal device 110 and the second communication capability of the network device 120, the terminal device 110 may receive (220) the network capability information from the network device 120. The terminal device 110 may then determine (225) whether its first communication capability matches the second communication capability of the network device 120. The matching result may indicate whether the first communication capability successfully matches or fails to match the second communication capability. The specific manner for determining the matching result will be discussed in detail below.

Furthermore, the terminal device 110 may transmit the matching result for the first communication capability and the second communication capability to the network device 120. Correspondingly, the network device 120 may receive, from the terminal device 110, the matching result for the first communication capability and the second communication capability.

In some example embodiments, if it is determined (230) that the matching result indicates that the first communication capability successfully matches the second communication capability, the terminal device 110 may transmit the matching result together with the terminal capability information to the network device 120. As discussed above, the terminal capability information may indicate the first communication capability of the terminal device 110. Correspondingly, the network device 120 may receive 240 the matching result and the terminal capability information from the terminal device 110.

For example, after receiving the matching result and the terminal capability information, the network device 120 may determine (245) its response information to the terminal capability information. In some example embodiments, the response information may include configuration information for the wired communication connection between the terminal device 110 and the network device 120.

Furthermore, based on the matching result indicating that the first communication capability successfully matches the second communication capability, the network device 120 may transmit, to the terminal device 110, the configuration information for the wired communication connection between the terminal device 110 and the network device 120. Correspondingly, the terminal device 110 may receive (255), from the network device 120, configuration information for the wired communication connection between the terminal device 110 and the network device 120. Here, the network device 120 may transmit (250) response information including the configuration information to the terminal device 110 in response to the terminal capability information of the terminal device 110. In other words, the configuration information may be included in the response of the network device 120 to the terminal capability information. Correspondingly, the terminal device 110 may receive (255) the response information including the configuration information.

Furthermore, based on the configuration information, the terminal device 110 may perform (260) communication with the network device 120 via the wired communication connection, and the network device 120 may perform (260) communication with the terminal device 110 via the wired communication connection.

In some example embodiments, the wired communication connection may be based on a HFC interface between the terminal device 110 and the network device 120.

For example, if the matching result indicates that the first communication capability fails to match the second communication capability, the terminal device 110 may transmit the matching result indicating the matching failure to the network device 120 without transmitting the terminal capability information.

It should be noted that, before the terminal device 110 and the network device 120 perform communication via the wired communication connection, i.e., steps 205 to 250, the manner of information transmission between the terminal device 110 and the network device 120 will be discussed in detail below.

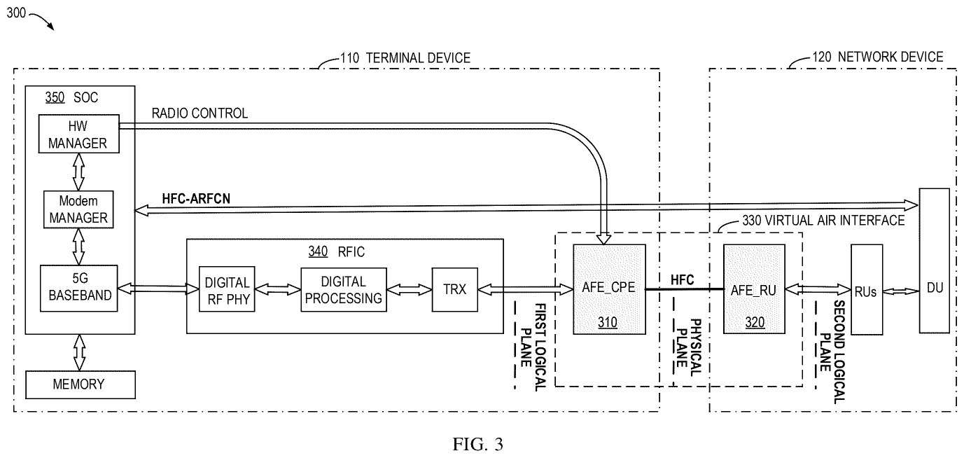

FIG. 3 illustrates a schematic diagram of an example system architecture 300 for implementing communication according to some example embodiments of the present disclosure. The system architecture 300 may be implemented in the communication network 100 of FIG. 1. The system architecture 300 may be illustrated as the architecture employed by the steps in the signaling chart 200.

As shown in FIG. 3, the system architecture 300 may include the terminal device 110, the network device 120, and a medium for wired communication connection between the terminal device 110 and the network device 120, such as HFC. In the following, some example embodiments of the present disclosure will be described by taking HFC as an example of the medium for wired communication connection and 3GPP as an example of wireless communication capability. It should be understood that the medium for wired communication connection may be, for example, the optical fiber, the coaxial cable, or the like.

The system architecture 300 may further include a physical plane of the HFC, a first logical plane in the terminal device 110, and a second logical plane in the network device 120. The logical plane (LP) may be 3GPP-supported air interface between traditional gNB and CPE. The physical plane (PP) may be used for the HFC cable interface. Therefore, at the LP, neither the terminal device 110 nor the network device 120 needs to change the protocol, and the part between the first logical plane and the second logical plane may serve as the virtual air interface 330. From the perspective of the 3GPP protocol stack, only the LP may be perceived, thus there is no need to modify the 3GPP protocol.

It should be noted that, unlike commercial chipsets used in terminals, the second logical plane of the network device 120 may be a “virtual logical plane”. The “virtual logical plane” may refer to that at the network side, due to the application of software-defined radio technology and the highly customized nature of the network side, the network side may simply require a “logical plane” at the “baseband/digital domain” level, without a “logical plane” at the “radio frequency” level.

In some example embodiments, the configuration information may at least include: a configuration for characterizing a physical plane of the wired communication connection between the terminal device 110 and the network device 120, a configuration of the first logical plane in the terminal device 110, the first logical plane being configured to connect the physical plane and a component in the terminal device 110 supporting the first wireless communications capability, and a configuration of the second logical plane in the network device 120, the second logical plane being configured to connect the physical plane and a component in the network device 120 supporting the second wireless communications capability.

In some example embodiments, the configuration information may at least include a configuration of a first analog front end (AFE) interfaced with the wired communication connection, the first AFE being configured to perform conversion of spatial division multiple access (SDMA) communication on a plurality of first ports corresponding to the first logical plane into frequency division multiple access (FDMA) communication corresponding to the physical plane. As shown in FIG. 3, the first analog front end 310 (i.e., the AFE_CPE) may be disposed in the terminal device 110.

In some example embodiments, the configuration information may at least include a configuration of a second AFE interfaced with the wired communication connection, the second AFE being configured to perform conversion of SDMA communication on a plurality of second ports corresponding to the second logical plane into FDMA communication corresponding to the physical plane. As shown in FIG. 3, the second analog front end 320 (i.e., AFE RU) may be disposed in the network device 120.

In some example embodiments, the terminal device 110 may further include a radio frequency integrated circuit (RFIC) 340 and a System on Chip (SOC) 350. The RFIC 340 may be configured to enable communication between itself and the first analog front end 310, and the communication between itself and the SOC 350. The SOC 350 may control the first analog front end 310 in a wireless manner.

In the system architecture 300, the HFC-ARFCN (absolute radio frequency channel number) may be configured to characterize the communication between the terminal device 110 and the network device 120. The HFC-ARFCN shown in the figure is connected between a modem manager and a distributed unit (DU). It should be understood that this is only an example. In other embodiments, the connection port of the HFC-ARFCN in the terminal device 110 may also be connected to an auto-configuration server (ACS), and then the ACS is connected to the hardware (HW) manager.

The embodiment in Table 1(a) explains how to define the HFC-ARFCN. For easier description, the downlink (DL) and uplink (UL) may share the same HC-ARCCN, although in fact they may be different due to the unique identification of DL or UL.

TABLE 1(a)
definition example of HFC-ARFCN between the network device and the terminal device

| | | | | | | | | | First Logical | |
|---|---|---|---|---|---|---|---|---|---|---|
| | | | | | | | | | Plane: terminal | |
| Second Logical Plane: network | | | | | | | | | device 110 side | |
| device 120 side n77 | | | | | | Physical | | | n77 | |
| | | Second | | | | Plane: HFC | | AFE | First | |
| | | Logical | | | | Physical | | LO | Logical | |
| | | Freq | | DU | CC | Freq | HFC- | Freq | Freq | |
| Sector | Carrier | (MHz) | Stream | ID | ID | (MHz) | ARFCN | (MHz) | (MHz) | Stream |
| RU | CC1 | 4150 | 0 | 0 | 0 | 1350 | HFCC1 | 5500 | 4150 | 0 |
| Sector | | | 1 | 0 | 0 | 1550 | HFCC3 | 5700 | | 1 |
| 0 | | | 2 | 0 | 0 | 1750 | HFCC5 | 5900 | | 2 |
| | | | 3 | 0 | 0 | 1950 | HFCC7 | 6100 | | 3 |
| | CC2 | 4050 | 0 | 0 | 1 | 1450 | HFCC2 | 5500 | 4050 | 0 |
| | | | 1 | 0 | 1 | 1650 | HFCC4 | 5700 | | 1 |
| | | | 2 | 0 | 1 | 1850 | HFCC6 | 5900 | | 2 |
| | | | 3 | 0 | 1 | 2050 | HFCC8 | 6100 | | 3 |
| RU | CC1 | 4150 | 0 | 1 | 0 | 2150 | HFCC9 | 6300 | 4150 | 0 |
| Sector | | | 1 | 1 | 0 | 2350 | HFCC11 | 6500 | | 1 |
| 1 | | | 2 | 1 | 0 | 2550 | HFCC13 | 6700 | | 2 |
| | | | 3 | 1 | 0 | 2750 | HFCC15 | 6900 | | 3 |
| | CC2 | 4050 | 0 | 1 | 1 | 2250 | HFCC10 | 6300 | 4050 | 0 |
| | | | 1 | 1 | 1 | 2450 | HFCC12 | 6500 | | 1 |
| | | | 2 | 1 | 1 | 2650 | HFCC14 | 6700 | | 2 |
| | | | 3 | 1 | 1 | 2850 | HFCC16 | 6900 | | 3 |
| RU | CC1 | 4150 | 0 | 2 | 0 | 2950 | HFCC17 | 7100 | 4150 | 0 |
| Sector | | | 1 | 2 | 0 | 3150 | HFCC19 | 7300 | | 1 |
| 2 | | | 2 | 2 | 0 | 3350 | HFCC21 | 7500 | | 2 |
| | | | 3 | 2 | 0 | 3550 | HFCC22 | 7700 | | 3 |
| | CC2 | 4050 | 0 | 2 | 1 | 3050 | HFCC18 | 7100 | 4050 | 0 |
| | | | 1 | 2 | 1 | 3250 | HFCC20 | 7300 | | 1 |
| | | | 2 | 2 | 1 | 3450 | HFCC22 | 7500 | | 2 |
| | | | 3 | 2 | 1 | 3650 | HFCC24 | 7700 | | 3 |
| RU | CC1 | 4150 | 0 | 3 | 0 | 3750 | HFCC25 | 7900 | 4150 | 0 |
| Sector | | | 1 | 3 | 0 | 3950 | HFCC27 | 8100 | | 1 |
| 3 | | | 2 | NA | NA | NA | NA | NA | | 2 |
| | | | 3 | NA | NA | NA | NA | NA | | 3 |
| | CC2 | 4050 | 0 | 3 | 1 | 3850 | HFCC26 | 7900 | 4050 | 0 |
| | | | 1 | NA | NA | NA | NA | NA | | 1 |
| | | | 2 | NA | NA | NA | NA | NA | | 2 |
| | | | 3 | NA | NA | NA | NA | NA | | 3 |

In Table 1(a), the HFC resource pool from the network device 120 may be composed by 27 continuous component carriers (CC) with bandwidth (BW) 100 MHz per CC for the target throughput. Specifically, take such configurations as an example: 1.3-4 GHz with BW 100 MHz per CC for NRoC-HFC frequency range, and DL 4×4 MIMO with 2 CCs per layer and UL 2×2 MIMO with 1 CC per layer are supported at LP of the terminal device 110. However, in fact, the frequency range, the BW and the MIMO layers are unlimited since the method is similar. To generate 27 carriers, for n77 4T4R RU, 4 sectors with instantaneous bandwidth (IBW) 200 MHz are needed (some carriers of Sector 3 are idle).

Regarding the specific manner for determining the matching result of the terminal device 110 and the network device 120 discussed above, reference can be made to Table 1(a) for determination based on various frequencies. For example, the determination may be based on the correspondence between the physical frequency of the HFC, the first logical frequency, the second logical frequency, and the like.

In the AFE configured to realize the transformation from the PP to LP in the terminal device 110, the AFE may be configured to realize the transformation between the LP and the PP. The AFE may include up and down converters for mapping between SDMA and FDMA, and up and down converters related local oscillator (LO) frequency may be found from HFC-ARFCN lookup table (LUT). The LO frequencies are given in the right list of Table 1(a). Table 1(b) provides a more detailed example of the AFE on the terminal device 110 side. The abbreviations involved in Table 1(b) are given here: TX (transmit), RX (receive), PRX (primary RX), DRX (diversity RX), MIMO (Multiple-Input Multiple-Output), M-PRX (MIMO-Primary RX), M-DRX (MIMO-Diversity RX).

TABLE 1(b)
DL LUT example about terminal device RX side
AFE for transformation between PP and LP

| | | | | | | Logical Plane: network device | | | |
|---|---|---|---|---|---|---|---|---|---|
| | | | | | | side n77 | | | |
| Physical Plane: HFC | | | AFE | | | | DL | | |
| | Physical | | | | LO | | Logical | PCC | DL |
| HFC- | Freq | IBW | | TX/ | Freq | DL | Freq | or | IBW |
| ARFCN | (MHz) | (MHz) | LO No. | RX | (MHz) | stream | (MHz) | SCC | (MHz) |
| HFCC1 | 1350 | 100 | 0 | PRX | 5500 | 0 | 4150 | PCC | 100 |
| HFCC2 | 1450 | 100 | | | | | 4050 | SCC | 100 |
| HFCC3 | 1550 | 100 | 1 | DRX | 5700 | 1 | 4150 | PCC | 100 |
| HFCC4 | 1650 | 100 | | | | | 4050 | SCC | 100 |
| HFCC5 | 1750 | 100 | 2 | M- | 5900 | 2 | 4150 | PCC | 100 |
| HFCC6 | 1850 | 100 | | PRX | | | 4050 | SCC | 100 |
| HFCC7 | 1950 | 100 | 3 | M- | 6100 | 3 | 4150 | PCC | 100 |
| HFCC8 | 2050 | 100 | | DRX | | | 4050 | SCC | 100 |

Therefore, in conjunction with Table 1(b), the HFC-ARFCN is the key information and indicates the relevant configuration of the network device 120 and the terminal device 110. Regarding the manner of information transmission between the terminal device 110 and the network device 120 before they communicate via the wired communication connection as discussed above, i.e., steps 205 to 250, a common HFC frequency (that is, HFC-ARFCN is selected) may be preset for the terminal device 110 and the network device 120, such that information transmission such as communication capability reporting may be performed between the terminal device 110 and the network device 120. The relationship between the HFC frequency (which is represented by F_{Phy}) and HFC-ARFCN may be expressed by the following formula:

$${F}_{P h y} = ( {N}_{HFC - ARFCN} ) ⋆ 100 MHz + 1350 MHz \qquad ( 1 )$$

The LP configuration for the network device 120 and the terminal device 110 may be found in Table 1(a), and the same applies to the LUT. For the network device 120 side, the configuration information may include the logical frequency, stream number, sector number, carer number, DU ID, and CC ID. In the terminal device 110 side, its configuration information may include logical frequency, and stream number.

In some embodiments, for a single carrier, the high-side LO may be used for better LO leakage rejection,

$${F}_{Ext . LO} = {F}_{Log} + {F}_{P h y} \qquad ( 2 )$$

In some embodiments, for DL continuous 2 carriers CA in the same stream at LP, both of Formula (3) & (4) should be satisfied simultaneously as shown in Table1(b):

$${F}_{Ext . LO} = {F}_{Log \_ CC 1} + {F}_{Phy \_ CC 1} \qquad ( 3 )$$

$${F}_{Ext . LO} = {F}_{Log \_ CC 2} + {F}_{Phy \_ CC 2} \qquad ( 4 )$$

In some embodiments, based on the capacity requirement of the operator, the network device 120 defines the mapping relationship between the LP and the PP, as shown in Table 2(a) below.

TABLE 2(a)
Mapping relationship between network device LP and PP

| | | | | | | Physical Plan: HFC | |
|---|---|---|---|---|---|---|---|
| Second Logical Plane: network device side n77 | | | | | | Physical | |
| | | Logical | | DU | CC | Freq | HFC- |
| Sector | Carrier | Freq (MHz) | Stream | ID | ID | (MHz) | ARFCN |
| RU Sector 0 | CC1 | 4150 | 0 | 0 | 1 | 1350 | HFCC1 |
| | | | 1 | 0 | 1 | 1550 | HFCC3 |
| | | | 2 | 0 | 1 | 1750 | HFCC5 |
| | | | 3 | 0 | 1 | 1950 | HFCC7 |
| | CC2 | 4050 | 0 | 0 | 0 | 1450 | HFCC2 |
| | | | 1 | 0 | 0 | 1650 | HFCC4 |
| | | | 2 | 0 | 0 | 1850 | HFCC6 |
| | | | 3 | 0 | 0 | 2050 | HFCC8 |
| RU Sector 1 | CC1 | 4150 | 0 | 0 | 1 | 2150 | HFCC9 |
| | | | 1 | 0 | 1 | 2350 | HFCC11 |
| | | | 2 | 0 | 1 | 2550 | HFCC13 |
| | | | 3 | 0 | 1 | 2750 | HFCC15 |
| | CC2 | 4050 | 0 | 0 | 0 | 2250 | HFCC10 |
| | | | 1 | 0 | 0 | 2450 | HFCC12 |
| | | | 2 | 0 | 0 | 2650 | HFCC14 |
| | | | 3 | 0 | 0 | 2850 | HFCC16 |
| RU Sector 2 | CC1 | 4150 | 0 | 0 | 1 | 2950 | HFCC17 |
| | | | 1 | 0 | 1 | 3150 | HFCC19 |
| | | | 2 | 0 | 1 | 3350 | HFCC21 |
| | | | 3 | 0 | 1 | 3550 | HFCC22 |
| | CC2 | 4050 | 0 | 0 | 0 | 3050 | HFCC18 |
| | | | 1 | 0 | 0 | 3250 | HFCC20 |
| | | | 2 | 0 | 0 | 3450 | HFCC22 |
| | | | 3 | 0 | 0 | 3650 | HFCC24 |
| RU Sector 3 | CC1 | 4150 | 0 | 0 | 1 | 3750 | HFCC25 |
| | | | 1 | 0 | 1 | 3950 | HFCC27 |
| | | | 2 | NA | NA | NA | NA |
| | | | 3 | NA | NA | NA | NA |
| | CC2 | 4050 | 0 | 0 | 0 | 3850 | HFCC26 |
| | | | 1 | NA | NA | NA | NA |
| | | | 2 | NA | NA | NA | NA |
| | | | 3 | NA | NA | NA | NA |

In the example shown in Table 2(a), when the communication capacity requires this kind of 27 carriers, for the 3 GPP-specific n77 4T4R RU, 4 sectors (with 4T4R, 2 CCs, 100 MHz per CC) are needed at LP (4 sectors*4 streams*2 CCs=32 carriers, and 3 sectors*4 streams*2 CCs=24 carriers), while physical frequency of 27 carriers at PP should be one-to-one matched with logical frequency per “DU & Stream & CC” at LP.

Based on Table 2(a), in some example embodiments, the second communication capability may indicate at least one of the following: a frequency range and a signal bandwidth for TDD communication in the second wireless communication capability of the network device 120, a second logical frequency range and a signal bandwidth for the second wireless communication capability supported by the second logical plane, a frequency range and a signal bandwidth of at least one transmit port at the second logical plane, a frequency range and a signal bandwidth of at least one receive port at the second logical plane, the number of transmit antennas at the second logical plane, the number of receive antennas at the second logical plane, the number of DUs at the second logical plane, and absolute radio frequency channel number information at the physical plane.

TABLE 2(b)
HFC-ARFCN related LUT example for 1 CC per stream in
LP (DL 4 × 4 MIMO, UL 2 × 2 MIMO)

| | | | First Logical Plane: | |
|---|---|---|---|---|
| Physical Plan: HFC | | AFE | terminal device side n77 | |
| Physical Freq | | LO Freq | Logical Freq | |
| (MHz) | HFC-ARFCN | (MHz) | (MHz) | Stream |
| 1350 | HFCC1 | 5400 | 4150 | 0 |
| 1550 | HFCC3 | 5600 | | 1 |
| 1750 | HFCC5 | 5800 | | 2 |
| 1950 | HFCC7 | 6000 | | 3 |
| 1450 | HFCC2 | 5600 | 4050 | 0 |
| 1650 | HFCC4 | 5800 | | 1 |
| 1850 | HFCC6 | 6000 | | 2 |
| 2050 | HFCC8 | 6200 | | 3 |
| 2150 | HFCC9 | 6200 | 4150 | 0 |
| 2350 | HFCC11 | 6400 | | 1 |
| 2550 | HFCC13 | 6600 | | 2 |
| 2750 | HFCC15 | 6800 | | 3 |
| 2250 | HFCC10 | 6400 | 4050 | 0 |
| 2450 | HFCC12 | 6600 | | 1 |
| 2650 | HFCC14 | 6800 | | 2 |
| 2850 | HFCC16 | 7000 | | 3 |
| 2950 | HFCC17 | 7000 | 4150 | 0 |
| 3150 | HFCC19 | 7200 | | 1 |
| 3350 | HFCC21 | 7400 | | 2 |
| 3550 | HFCC22 | 7600 | | 3 |
| 3050 | HFCC18 | 7200 | 4050 | 0 |
| 3250 | HFCC20 | 7400 | | 1 |
| 3450 | HFCC22 | 7600 | | 2 |
| 3650 | HFCC24 | 7800 | | 3 |
| 3750 | HFCC25 | 7800 | 4150 | 0 |
| 3950 | HFCC27 | 8000 | | 1 |
| NA | NA | NA | | 2 |
| NA | NA | NA | | 3 |
| 3850 | HFCC26 | 8000 | 4050 | 0 |
| NA | NA | NA | | 1 |
| NA | NA | NA | | 2 |
| NA | NA | NA | | 3 |

By comparing Table 2(b) with Table 2(a), for each HFC-ARCN, under the 3GPP-specified protocol stack, the logical frequency of the terminal device 110 may be the same as that of the network device 120.

TABLE 2(c)
HFC-ARCN in lower band group related DL LUT example: for DL 2CCs
per stream in one- terminal-device-side LP (DL 4 × 4 MIMO)

| | | | | | | Logical Plane: terminal device side n77 | | | |
|---|---|---|---|---|---|---|---|---|---|
| Physical Plan: HFC | | | | | | | DL | | |
| HFC- | Physic | | AFE | | | | Logical | PCC | |
| ARFC | Freq | IBW | LO | TX/R | LO Freq | DL | Freq | or | DL IBW |
| N | (MHz) | (MHz) | No. | X | (MHz) | stream | (MHz) | SCC | (MHz) |
| HFCC1 | 1350 | 100 | 0 | PRX | 5500 | 0 | 4150 | PCC | 100 |
| HFCC2 | 1450 | 100 | | | | | 4050 | SCC | 100 |
| HFCC3 | 1550 | 100 | 1 | DRX | 5700 | 1 | 4150 | PCC | 100 |
| HFCC4 | 1650 | 100 | | | | | 4050 | SCC | 100 |
| HFCC5 | 1750 | 100 | 2 | M- | 5900 | 2 | 4150 | PCC | 100 |
| HFCC6 | 1850 | 100 | | PRX | | | 4050 | SCC | 100 |
| HFCC7 | 1950 | 100 | 3 | M- | 6100 | 3 | 4150 | PCC | 100 |
| HFCC8 | 2050 | 100 | | DRX | | | 4050 | SCC | 100 |

In a further embodiment as shown in Table 2(c), for DL 2 CCs per stream at LP, the frequency of the RX local oscillator may be calculated according to formulas (3) and (4).

TABLE 2(d)
HFC-ARCN in lower band group related UL LUT example: for UL
1CC per stream in the terminal device side LP (UL 2 × 2 MIMO)

| | | | | | | First Logical Plane: terminal | | |
|---|---|---|---|---|---|---|---|---|
| | | | | | | device side n77 | | |
| Physical Plan: HFC | | | AFE | | | | UL | |
| | Physical | | | | TX LO | | Logical | |
| HFC- | Freq | IBW | TX LO | | Freq | UL | Freq | UL |
| ARFCN | (MHz) | (MHz) | No. | TX/RX | (MHz) | Stream | (MHz) | IBW(MHz) |
| HFCC1 | 1350 | 100 | 0 | PTX | 5500 | 0 | 4150 | 100 |
| HFCC3 | 1550 | 100 | 1 | DTX | 5700 | 1 | 4150 | 100 |

In a further embodiment as shown in Table 2(d), for UL 1 CC per stream at LP, RX LOs' frequency may be calculated from Formula (2). The abbreviations involved in Table 2(d) are given here: TX (transmit), PTX (primary TX), DTX (diversity TX). Due to the necessity of the uniformity of LPs between the network device 120 and the terminal device 110, carriers at the PP may be incontiguous.

Based on the tables 2(c) and 2(d), in some example embodiments, the first communication capability may indicate at least one of the following: a frequency range and a signal bandwidth for time division duplex, TDD, communication in the first wireless communication capability of the terminal device 110, a first logical frequency range and a signal bandwidth for the first wireless communication capability supported by the first logical plane, a frequency range and a signal bandwidth of the at least one transmit port at the first logical plane, a frequency range and a signal bandwidth of the at least one receive port at the first logical plane, the number of transmit antennas at the first logical plane, the number of receive antennas at the first logical plane, absolute ARFCN information at the physical plane.

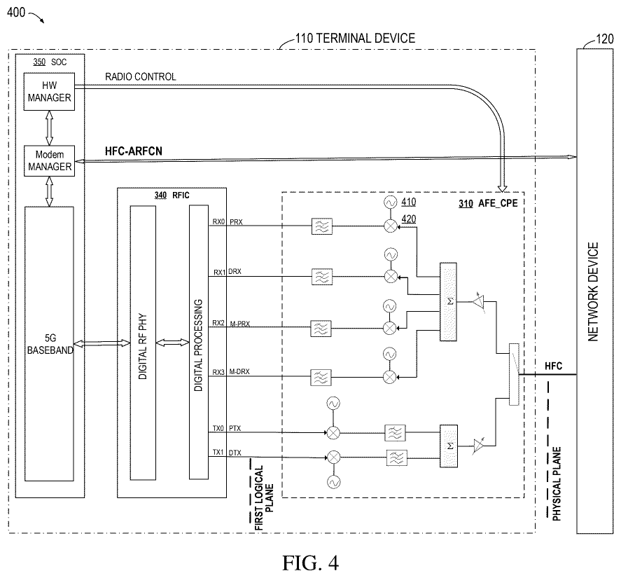

FIG. 4 illustrates a schematic diagram of a partial example architecture 400 for the system architecture 300 in FIG. 3 according to some example embodiments of the present disclosure.

As shown in FIG. 4, in some example embodiments, the first analog front end 310 may include a plurality of first frequency conversion components that may be configured to perform frequency conversion between the first logical plane and the physical plane. Each first frequency conversion component may at least include a first local oscillator 410 and a corresponding first frequency converter 420.

In some example embodiments, the second analog front end may include a plurality of second frequency conversion components configured to perform frequency conversion between the second logical plane and the physical plane. Each second frequency conversion component may at least include a second local oscillator and a corresponding second frequency converter, and the second local oscillator is corresponding to one of the plurality of second ports corresponding to the second logical plane.

In addition, the baseband chip of the network device 120 may be customized, and the physical plane of the baseband chip may be converted into a virtual logical plane. The actual RF frequency of the virtual logical plane may not correspond to the signaling frequency (on the network side: it is sufficient to declare the signaling frequency), which makes the actual implementation of the “AFE” on the network side more flexible. The analog front end of the network side may also directly adopt the radio frequency sampling manner without performing frequency conversion.

The frequency of the local oscillator 410 may be seen in Tables 2(c) and 2(d). It may be learned that the LP between the network device 120 and the terminal device 110 may coexist, and the HFC is served as the virtual air interface compatible with the 3GPP protocol. The HW manager may configure the local oscillator through a digital interface (such as a serial peripheral interface (SPI)).

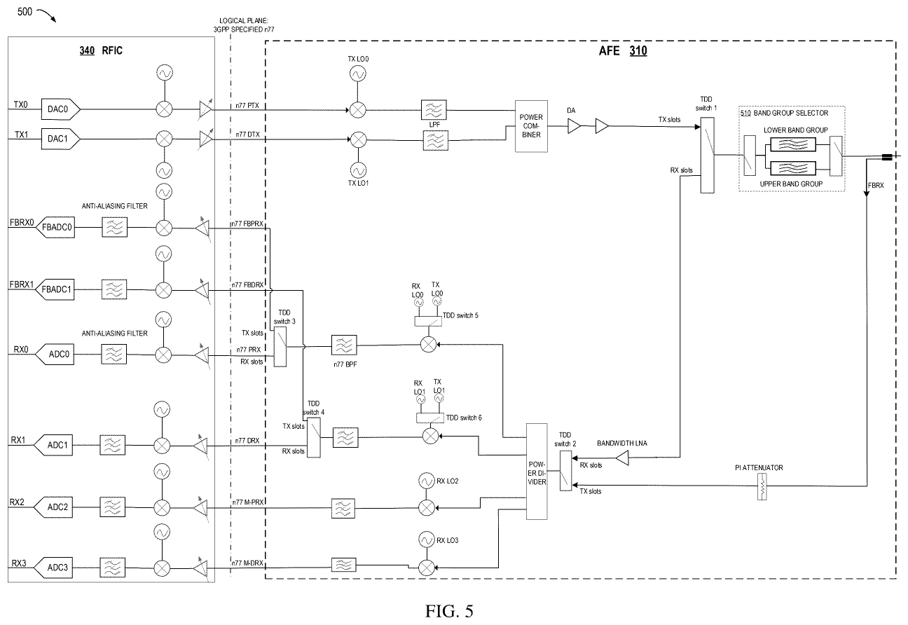

FIG. 5 illustrates a schematic diagram of a partial example architecture 500 for the system architecture 300 in FIG. 3 according to some example embodiments of the present disclosure.

As shown in FIG. 5, in some example embodiments, the first analog front end 310 may include a band group selector 510. The band group selector 510 may be configured to select, from a plurality of ARFCN groups at the physical plane, a target ARFCN group for UL and DL communications between the terminal device 110 and the network device 120. For example, the plurality of ARFCN groups may correspond to, e.g., an upper band group and a lower band group, respectively.

TABLE 2(e)
HFC-ARFCN in upper band group related DL LUT example: for DL
2CCs per stream in terminal device side LP (DL 4 × 4 MIMO)

| | | | | | | Logical Plane: terminal device side n77 | | | |
|---|---|---|---|---|---|---|---|---|---|
| Physical Plan: HFC | | | | | | | DL | | |
| | Physic | | AFE | | | | Logical | PCC | |
| HFC- | Freq | IBW | LO | | LO Freq | DL | Freq | or | DL IBW |
| ARFCN | (MHz) | (MHz) | No. | TX/RX | (MHz) | Stream | (MHz) | SCC | (MHz) |
| HFCC9 | 2150 | 100 | 0 | PRX | 6300 | 0 | 4150 | PCC | 100 |
| HFCC10 | 2250 | 100 | | | | | 4050 | SCC | 100 |
| HFCC11 | 2350 | 100 | 1 | DRX | 6500 | 1 | 4150 | PCC | 100 |
| HFCC12 | 2450 | 100 | | | | | 4050 | SCC | 100 |
| HFCC13 | 2550 | 100 | 2 | M- | 6700 | 2 | 4150 | PCC | 100 |
| HFCC14 | 2650 | 100 | | PRX | | | 4050 | SCC | 100 |
| HFCC15 | 2750 | 100 | 3 | M- | 6900 | 3 | 4150 | PCC | 100 |
| HFCC16 | 2850 | 100 | | DRX | | | 4050 | SCC | 100 |

TABLE 2(f)
HFC-ARFCN in upper band group related UL LUT example: for UL
1CC per stream in terminal device side LP (UL 2 × 2 MIMO)

| | | | | | | Logical plane: terminal device | | |
|---|---|---|---|---|---|---|---|---|
| | | | | | | side n77 | | |
| Physical Plan: HFC | | | AFE | | | | UL | |
| | Physical | | | | TX LO | | Logical | |
| HFC- | Freq | IBW | TX LO | | Freq | | Freq | IBW |
| ARFCN | (MHz) | (MHz) | No. | TX/RX | (MHz) | stream | (MHz) | (MHz) |
| HFCC9 | 2150 | 100 | 0 | PTX | 6300 | 0 | 4150 | 100 |
| HFCC11 | 2350 | 100 | 1 | DTX | 6500 | 1 | 4150 | 100 |

For this embodiment, since the HFC operates in the upper band group, the HW manager may configure the band group to select “upper band group” by the digital interface (i.e., GPIO). For example, in the upper band group, the DL HFC-ARFCN may include HFCC9-HFCC16, while the UL HFC ARCCN may include HFCC9 and HFCC11. In the lower band group, the DL HFC-ARFCN may include HFCC1-HFCC8, while the UL HFC-ARFCN may include HFCC1 and HFCC3.

As shown in FIG. 5, since there are 2 logical ports n77 PTX/DTX and 1 physical ports, a power combiner is needed. Here, the up converter, the TX LO, the 4 GHz LPF may be used for either path, and the wideband DA (driver amplifier) and the PA (power amplifier) and the band group selector 510 may be used for a common path. Here, the 4 GHz LPF is used for rejecting other unwanted spurs like “m*f_{Lo}±n*f_{RF}” (“f_{LO}−f_{RF}” excluded, m and n are natural number). DA may be used for driving the PA, and TDD switch may be used for switching TX and RX paths. The band group selector 510 may be used for rejecting second harmonic of lower band which may fall in the whole HFC range (for example, 2*1300 MHz=2600 MHz, 2*2000 MHz=4000 MHz). The lower band is 1.3 GHz-2.6 GHz while upper band is 2 GHz-4 GHz. The switching between the lower band and the upper band may be determined by the hardware manager with the specified HFC-ARFCN. There is an overlap between the lower band and the upper band for meeting the flexible frequency combination at the LP. For example, as shown in Table 1(a), at the LP, the frequency range of RU sector 0 of the network device 120: 1300-2100 MHz; sector 1: 2100-2900 MHz; sector 2: 2900-3700 MHz, etc.

At the LP, the frequency of PTX and DTX is 4150 MHz. Then, with different frequency f_{TxLo0} 5.5 GHz and f_{TXLO1} GHz, the logic frequency may be up converted to 1350 MHz and 1550 MHz. Finally, at the PP, 2 incontiguous CA carriers with the frequency of 1350 MHz and 1550 MHz may be obtained.

There are 27 RX carriers at the PP, and about 13 carriers after the band group selector 510. Then at per port of LP, there are 10 carriers after mixer and band pass filter (BPF). After that, the RFIC internal mixer, the anti-aliasing filter and the digital filter are used for producing pure 2 CCs.

Typically, FBRX is used for TX output power control. To share the TX and RX parts for cost saving, TDD switches 2/3/4 are used for FBRX0&1 to share the parts of the down converters and BPFs of RX0&1. TDD switches 5/6 are used for FBRX0&1 to share the parts of LOs of TX0&1 (FBRXs have the same characteristic with respective TXs). Here, TX LOs are independent with RX LOs for flexible frequency configuration, even though TX LO0 & RX LO0 could be shared and TX LO1 & RX LO1 could be shared in this embodiment.

The band group selector 510 is configured to reject IF/2 (half-intermediate frequency) interference at the lower band while band pass for the upper band. For the terminal device 110 DL, Table 3 below analyzes the unwanted RX signal in Table 1(a).

TABLE 3
Unwanted RX signal list in terminal device DL

| | LO | | Image | 1/2f_IF |
|---|---|---|---|---|
| RF | Freq | IF | (RF HFC | (RF HFC |
| (HFC) | (Physical) | (n77) | Port) | Port) |
| (MHz) | (MHz) | (MHz) | (MHz) | (MHz) |
| 1350 | 5500 | 4150 | 9650 | 3425 |
| 1450 | 5600 | 4150 | 9750 | 3525 |
| 1550 | 5700 | 4150 | 9850 | 3625 |
| 1650 | 5800 | 4150 | 9950 | 3725 |
| 1750 | 5900 | 4150 | 10050 | 3825 |
| 1850 | 6000 | 4150 | 10150 | 3925 |
| 1950 | 6100 | 4150 | 10250 | 4025 |
| 2050 | 6200 | 4150 | 10350 | 4125 |
| 2150 | 6300 | 4150 | 10450 | 4225 |
| 2250 | 6400 | 4150 | 10550 | 4325 |
| 2350 | 6500 | 4150 | 10650 | 4425 |
| 2450 | 6600 | 4150 | 10750 | 4525 |
| 2550 | 6700 | 4150 | 10850 | 4625 |
| 2650 | 6800 | 4150 | 10950 | 4725 |
| 2750 | 6900 | 4150 | 11050 | 4825 |
| 2850 | 7000 | 4150 | 11150 | 4925 |
| 2950 | 7100 | 4150 | 11250 | 5025 |
| 3050 | 7200 | 4150 | 11350 | 5125 |
| 3150 | 7300 | 4150 | 11450 | 5225 |
| 3250 | 7400 | 4150 | 11550 | 5325 |
| 3350 | 7500 | 4150 | 11650 | 5425 |
| 3450 | 7600 | 4150 | 11750 | 5525 |
| 3550 | 7700 | 4150 | 11850 | 5625 |
| 3650 | 7800 | 4150 | 11950 | 5725 |
| 3750 | 7900 | 4150 | 12050 | 5825 |
| 3850 | 8000 | 4150 | 12150 | 5925 |
| 3950 | 8100 | 4150 | 12250 | 6025 |

$${F}_{IF} = {F}_{Ext . LO} - {F}_{RF ( wanted )} \qquad ( 5 )$$

$${F}_{i m g} = {F}_{RF} - {F}_{IF} \qquad ( 6 )$$

$$2 ⋆ ( {F}_{Ext . LO} - {F}_{R F ( IF / 2 )} ) = {F}_{IF} \qquad ( 7 )$$

Since 3425 MHz to 4025 MHz of f_{IF/2} interference is in the NRoC frequency range, the band group selector 510 is required.

FIG. 6 illustrates a schematic diagram of an example architecture 600 for offline radio frequency calibration according to some example embodiments of the present disclosure. The architecture 600 may include the system architecture 300 in FIG. 3.

As shown in FIG. 6, in some example embodiments, the network device 120 further includes an inverse analog front end (IAFE) 610 and a corresponding mirror logical plane (MLP). The network device 120 may obtain a calibration parameter of the inverse analog front end. The calibration parameter may be associated with a calibration frequency corresponding to the mirror logical plane. The network device 120 may measure signal related information at the mirror logical plane. The signal related information may be associated with the calibration frequency. The network device 120 may obtain signal information corresponding to the physical plane based on the calibration parameter and the signal related information.

In such an example embodiment, the IAFE may be used to realize the transformation between PP and MLP, and adopts a de-embedded self-calibration approach for offline RF calibration.

For the terminal device 110, the external interface is PP, but the RF calibration requires the network device 120 simulator to operate at the LP. Thus, the IAFE is used for realizing the transformation between PP and MLP. The IAFE module should have the same reference clock with the AFE for strict synchronization.

At 120, unlike the gNB simulator, the below frequency conversion loss can be gotten by using network analyzer:

$${IL}_{TX path m} @ {F}_{MLP} ( from related F\_PP to F\_MLP ) \qquad ( 8 )$$

$${I}_{LRX path n} @ {F}_{MLP} ( from F\_MLP to related F\_PP ) \qquad ( 9 )$$

In conjunction with FIG. 6, in formulas (8) and (9), m may represent 0 to 1, corresponding to 2 channels (paths) of TX, which are TX0 and TX1, respectively; n may represent 0 to 3, corresponding to 4 channels of RX, which are RX0, RX1, RX2, RX3, respectively; @F_{MLP} may represent the frequency associated with the MLP; “from related F_PP to F_MLP” may represent the frequency from the frequency of the related PP to the MLP; and “from F_MLP to related F_PP” may represent the frequency from the frequency of the MLP to the related PP.

When the simulator of the network device 120 measures the following power at the MLP, the TX output power may be represented by the following formula:

$${P}_{TX path m , MLP} @ {F}_{MLP} \qquad ( 10 )$$

The RX sensitivity may be represented by the following formula:

$${P}_{res \_ RX path n , MLP} @ {F}_{MLP} \qquad ( 11 )$$

In the formula (11), “res” may represent the reference sensitivity.

Thus, the related power at the PP can be obtained. Specifically, the TX output power may be represented by the following formula:

$${P}_{TX , PP ( related TX path m and F \_ MLP} ) @ {F}_{PP} = {P}_{TX path m , MLP} @ {F}_{MLP} + I {L}_{TX path m} @ {F}_{MLP ( from related F \_ PP to F \_ MLP )} \qquad ( 12 )$$

Thus, TX output power “P_{TX, PP (related TX path m and F_MLP)}@F_{PP}” may be expressed as the sum of formula (10) and formula (8).

The RX sensitivity may be represented by the following formula:

$${P}_{res , PP ( related RX path n and F \_ MLP} ) @ {F}_{PP} = {P}_{res \_ RX path n , MLP} @ {F}_{MLP} + I {L}_{RX path n} @ {F}_{MLP ( from F \_ MLP to related F \_ P P )} \qquad ( 13 )$$

Thus, the RX sensitivity “P_{res, PP (related RX path n and F_MLP)}@F_{PP}” may be expressed as the sum of formula (11) and formula (9).

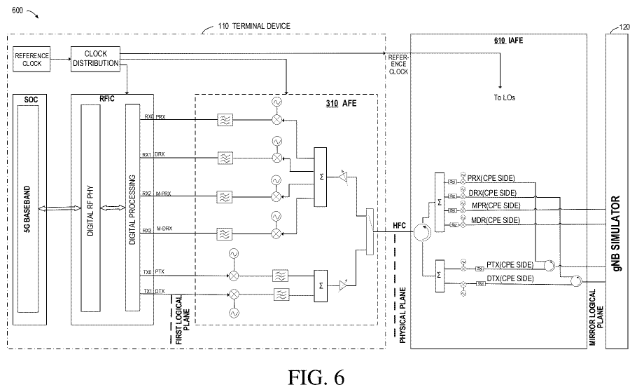

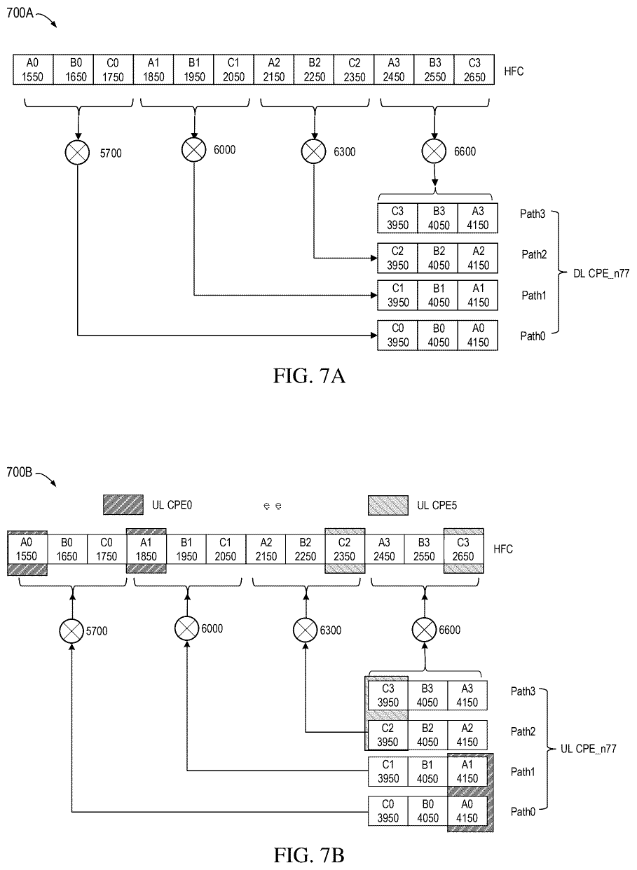

FIG. 7A illustrates a schematic diagram of an example frequency configuration 700A at a receiving end according to some example embodiments of the present disclosure. FIG. 7B illustrates a schematic diagram of an example frequency configuration 700B at a transmit end according to some example embodiments of the present disclosure. Example frequency configurations 700A and 700B may be applied to frequency configurations during initialization of broadcast information or service information configuration. During initialization, in the example frequency configuration 700A (previously agreed on by the network device and the terminal device sides), different frequency converters may be used for different downlink paths (such as path0 to path3) to achieve HFC frequency conversion. During initialization, in example frequency configuration 700B, for different terminal devices 110 (e.g., CPE 0, CPE 5, etc.), different frequency converters may be used for different uplink paths (such as path0 to path3) to achieve HFC frequency conversion. The frequency of the frequency converter may be, for example, 5700 MHz, 6000 MHz, 6300 MHz, 6600 MHz, or the like. This may be used for information transmission such as capability reporting between the terminal device 110 and the network device 120.

With the embodiments of the present disclosure, the wireless communication capability may be easily implemented on the terminal device 110 side by using a cable interface instead of an air interface. This may achieve 3GPP-compliant protocol stacks, more capacity (e.g., up to 20 Gbps), and significantly cheaper investment compared to fibers (or absolutely new NRoC end-to-end system).

Example embodiments of the present disclosure further provide a terminal device. The terminal device may be implemented as the terminal device 110 in FIG. 1 to FIG. 6. Referring to FIG. 3, the terminal device 110 is connected to the network device 120 through a physical transmission medium. The terminal device 110 includes a first logical plane configured to connect between a physical plane and a component in the terminal device 110 supporting a first wireless communication capability, the physical plane being configured to characterize a wired communication connection based on the physical transmission medium between the terminal device 110 and the network device 120. The terminal device 110 further includes a first analog front end (AFE) 310 connected to the first logical plane and the physical transmission medium, respectively. The terminal device 110 further includes a controller configured to control the terminal device 110 to perform wired communication with the network device 120 via the physical transmission medium based on configuration information for the wired communication connection.

In some example embodiments, the controller may further be configured to: control the first AFE 310 to convert spatial division multiple access communication on a plurality of first ports corresponding to the first logical plane into frequency division multiple access communication corresponding to the physical plane, to enable the terminal device 110 to perform communication with the network device 120 via the physical transmission medium.

Referring to FIG. 5, in some example embodiments, the first AFE 310 may include a band group selector 510 configured to select, from a plurality of absolute radio frequency channel number, ARFCN, groups at the physical plane, a target ARFCN group for allocation to uplink and downlink communications between the terminal device 110 and the network device 120.

In some example embodiments, the first AFE may include a plurality of frequency conversion components configured to perform frequency conversion between the first logical plane and the physical plane.

Referring to FIG. 4, in some example embodiments, each of the plurality of frequency conversion components may at least include a local oscillator 410 and a corresponding frequency converter 420. The local oscillator 410 may correspond to one of the plurality of first ports corresponding to the first logical plane. The plurality of first ports may include, for example, a PRX port, a DRX port, an M-PRX port, an M-DRX port, a PTX port, a DTX port, or the like.

Referring back to FIG. 3, in some example embodiments, the first AFE 310 may be connected to the second AFE 320 in the network device 120 through the physical transmission medium. The second AFE 320 may be configured to convert spatial division multiple access (SDMA) communication on a plurality of second ports corresponding to a second logical plane at a side of the network device 120 into frequency division multiple access (FDMA) communication corresponding to the physical plane. The second logical plane may be configured to connect the physical plane with a component in the network device 120 supporting a second wireless communication capability.

In some example embodiments, the physical transmission medium may include a HFC interface. In some example embodiments, the terminal device 110 may include CPE.

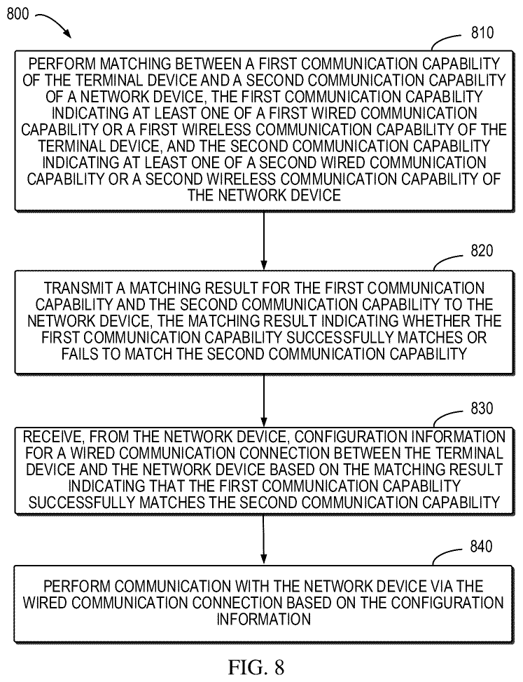

FIG. 8 illustrates a flowchart of a communication method 800 according to some example embodiments of the present disclosure. The method 800 may be implemented, for example, at a communication device, such as at the terminal device 110 in FIG. 1.

At block 810, the terminal device 110 performs matching between a first communication capability of the terminal device 110 and a second communication capability of the network device, where the first communication capability indicates at least one of a first wired communication capability or a first wireless communication capability of the terminal device, and the second communication capability indicates at least one of a second wired communication capability or a second wireless communication capability of the network device.

At block 820, the terminal device 110 transmits a matching result for the first communication capability and the second communication capability to the network device, where the matching result indicates whether the first communication capability successfully matches or fails to match the second communication capability.

At block 830, the terminal device 110 indicates, from the network device, configuration information for a wired communication connection between the terminal device and the network device based on the matching result indicating that the first communication capability successfully matches the second communication capability.

At block 840, the terminal device 110 performs communication with the network device via the wired communication connection based on the configuration information.

In some example embodiments, performing the matching between the first communication capability of the terminal device and the second communication capability of the network device includes: receiving the network capability information from the network device, where the network capability information indicates the second communication capability of the network device.

In some example embodiments, the method 800 further includes: based on the matching result indicating that the first communication capability successfully matches the second communication capability, transmitting terminal capability information to the network device, where the terminal capability information indicates the first communication capability of the terminal device. The configuration information is included in a response of the network device to the terminal capability information.

In some example embodiments, the configuration information at least includes: a configuration for characterizing a physical plane of the wired communication connection between the terminal device and the network device, a configuration of a first logical plane in the terminal device, the first logical plane being configured to connect the physical plane and a component in the terminal device supporting the first wireless communications capability, and a configuration of a second logical plane in the network device, the second logical plane being configured to connect the physical plane and a component in the network device supporting the second wireless communications capability.

In some example embodiments, the configuration information at least includes a configuration of a first analogue front end (AFE) interfaced with the wired communication connection, the first AFE being configured to perform conversion of spatial division multiple access communication on a plurality of first ports corresponding to the first logical plane into frequency division multiple access communication corresponding to the physical plane.

In some example embodiments, the first communication capability indicates at least one of a frequency range and a signal bandwidth for time division duplex (TDD) communication in the first wireless communication capability of the terminal device, a first logical frequency range and a signal bandwidth for the first wireless communication capability supported by the first logical plane, a frequency range and a signal bandwidth of the at least one transmit port at the first logical plane, a frequency range and a signal bandwidth of the at least one receive port at the first logical plane, a number of transmit antennas at the first logical plane, a number of receive antennas at the first logical plane, ARFCN information at the physical plane.

In some example embodiments, the second communication capability indicates at least one of a frequency range and a signal bandwidth for TDD communication in the second wireless communication capability of the network device, a second logical frequency range and a signal bandwidth for the second wireless communication capability supported by the second logical plane, a frequency range and a signal bandwidth of the at least one transmit port at the second logical plane, a frequency range and a signal bandwidth of the at least one receive port at the second logical plane, a number of transmit antennas at the second logical plane, a number of receive antennas at the second logical plane, a number of DUs at the second logical plane, and ARFCN information at the physical plane.

In some example embodiments, the first analog front end includes a band group selector configured to select, from a plurality of absolute radio frequency channel number, ARFCN, groups at the physical plane, a target ARFCN group for allocation to uplink and downlink communications between the terminal device and the network device.

In some example embodiments, the first analog front end includes a plurality of frequency conversion components configured to perform frequency conversion between the first logical plane and the physical plane, each frequency conversion component at least includes a local oscillator and a corresponding frequency converter, and the local oscillator corresponds to one of the plurality of first ports corresponding to the first logical plane.

In some example embodiments, the wired communication connection is based on a hybrid fiber coax (HFC) interface between the terminal device and the network device, and/or the terminal device includes CPE.

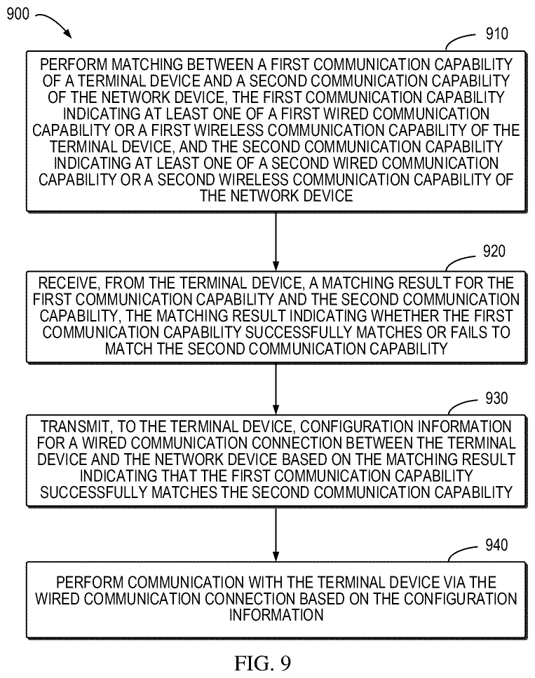

FIG. 9 illustrates a flowchart of a communication method 900 according to some example embodiments of the present disclosure. The method 900 may, for example, be implemented at a communication device, such as at a network device 120.

At block 910, the network device 120 performs matching between a first communication capability of the terminal device and a second communication capability of the network device, where the first communication capability indicates at least one of a first wired communication capability or a first wireless communication capability of the terminal device, and the second communication capability indicates at least one of a second wired communication capability or a second wireless communication capability of the network device.

At block 920, the network device 120 receives, from the terminal device, a matching result for the first communication capability and the second communication capability, where the matching result indicates whether the first communication capability successfully matches or fails to match the second communication capability.

At block 930, the network device 120 transmits, to the terminal device, configuration information for a wired communication connection between the terminal device and the network device based on the matching result indicating that the first communication capability successfully matches the second communication capability.

At block 940, the network device 120 performs communication with the terminal device via the wired communication connection based on the configuration information.

In some example embodiments, performing the matching between the first communication capability of the terminal device and the second communication capability of the network device includes: transmitting network capability information to the terminal device, where the network capability information indicates the second communication capability of the network device.

In some example embodiments, the method 900 further includes: in response to determining that the matching result indicates that the first communication capability successfully matches the second communication capability, receiving terminal capability information from the terminal device, where the terminal capability information indicates the first communication capability of the terminal device. The configuration information is included in a response of the network device to the terminal capability information.

In some example embodiments, the configuration information at least includes: a configuration for characterizing a physical plane of the wired communication connection between the terminal device and the network device, a configuration of a first logical plane in the terminal device, the first logical plane being configured to connect the physical plane and a component in the terminal device supporting the first wireless communications capability, and a configuration of a second logical plane in the network device, the second logical plane being configured to connect the physical plane and a component in the network device supporting the second wireless communications capability.

In some example embodiments, the configuration information at least includes a configuration of a second analog front end (AFE) interfaced with the wired communication connection, where the second AFE is configured to perform conversion of spatial division multiple access communication on a plurality of second ports corresponding to the second logical plane into frequency division multiple access communication corresponding to the physical plane.

In some example embodiments, the first communication capability indicates at least one of a frequency range and a signal bandwidth for a time division duplex (TDD) communication in the first wireless communication capability of the terminal device, a first logical frequency range and a signal bandwidth for the first wireless communication capability supported by the first logical plane, a frequency range and a signal bandwidth of the at least one transmit port at the first logical plane, a frequency range and a signal bandwidth of the at least one receive port at the first logical plane, a number of transmit antennas at the first logical plane, a number of receive antennas at the first logical plane, ARFCN information at the physical plane.

In some example embodiments, the second communication capability indicates at least one of a frequency range and a signal bandwidth for time division duplex (TDD) communication in the second wireless communication capability of the network device, a second logical frequency range and signal bandwidth for the second wireless communication capability supported by the second logical plane, a frequency range and a signal bandwidth of the at least one transmit port at the second logical plane, a frequency range and a signal bandwidth of the at least one receive port at the second logical plane, a number of transmit antennas at the second logical plane, a number of receive antennas at the second logical plane, a number of DUs at the second logical plane, and ARFCN information at the physical plane.

In some example embodiments, the network device further includes an inverse analog front end and a corresponding mirror logical plane, and the method 900 further includes: obtaining a calibration parameter of the inverse analog front end, the calibration parameter being associated with a calibration frequency corresponding to the mirror logical plane; measuring signal related information at the mirror logical plane, the signal related information being associated with the calibration frequency; and obtaining signal information corresponding to the physical plane based on the calibration parameter and the signal related information. In some example embodiments, obtaining the calibration parameter of the inverse analog front end may include obtaining the calibration parameter of the inverse analog front end from a network analyzer.

In some example embodiments, the wired communication connection is based on a hybrid fiber coax (HFC) interface between the terminal device and the network device, and/or the terminal device includes CPE.

Example embodiments of the present disclosure further provide an apparatus for communication. The means for communicating may include means for performing respective steps of the method 800. The means may be implemented in any suitable manner. For example, the means may be implemented as a circuit device or a software module.

The apparatus for communication may include: means for performing matching between a first communication capability of a terminal device and a second communication capability of the network device, where the first communication capability indicates at least one of a first wired communication capability or a first wireless communication capability of the terminal device, and the second communication capability indicates at least one of a second wired communication capability or a second wireless communication capability of the network device; means for transmitting a match result for the first communication capability and the second communication capability to a network device, where the match result indicates whether the first communication capability successfully matches or fails to match the second communication capability; means for receiving, from the network device, configuration information for a wired communication connection between the terminal device and the network device based on the matching result indicating that the first communication capability successfully matches the second communication capability; and means for performing communication with the network device via the wired communication connection based on the configuration information.

In some example embodiments, the means for communicating may include means for receiving network capability information from the network device, the network capability information indicating the second communication capability of the network device.

In some example embodiments, the apparatus for communicating may further include means for transmitting terminal capability information to the network device based on the matching result indicating that the first communication capability successfully matches the second communication capability, the terminal capability information indicating a first communication capability of the terminal device. The configuration information is included in a response of the network device to the terminal capability information.

In some example embodiments, the configuration information at least includes: a configuration for characterizing a physical plane of the wired communication connection between the terminal device and the network device, a configuration of a first logical plane in the terminal device, the first logical plane being configured to connect the physical plane and a component in the terminal device supporting the first wireless communications capability, and a configuration of a second logical plane in the network device, the second logical plane being configured to connect the physical plane and a component in the network device supporting the second wireless communications capability.

In some example embodiments, the configuration information at least includes a configuration of a first analogue front end (AFE) interfaced with the wired communication connection, the first AFE being configured to perform conversion of spatial division multiple access communication on a plurality of first ports corresponding to the first logical plane into frequency division multiple access communication corresponding to the physical plane.

In some example embodiments, the first communication capability indicates at least one of a frequency range and a signal bandwidth for time division duplex (TDD) communication in the first wireless communication capability of the terminal device, a first logical frequency range and a signal bandwidth for the first wireless communication capability supported by the first logical plane, a frequency range and a signal bandwidth of the at least one transmit port at the first logical plane, a frequency range and a signal bandwidth of the at least one receive port at the first logical plane, a number of transmit antennas at the first logical plane, a number of receive antennas at the first logical plane, ARFCN information at the physical plane.

In some example embodiments, the second communication capability indicates at least one of a frequency range and a signal bandwidth for TDD communication in the second wireless communication capability of the network device, a second logical frequency range and a signal bandwidth for the second wireless communication capability supported by the second logical plane, a frequency range and a signal bandwidth of the at least one transmit port at the second logical plane, a frequency range and a signal bandwidth of the at least one receive port at the second logical plane, a number of transmit antennas at the second logical plane, a number of receive antennas at the second logical plane, a number of DUs at the second logical plane, and ARFCN information at the physical plane.

In some example embodiments, the first analog front end includes a band group selector configured to select, from a plurality of absolute radio frequency channel number, ARFCN, groups at the physical plane, a target ARFCN group for allocation to uplink and downlink communications between the terminal device and the network device.

In some example embodiments, the first analog front end includes a plurality of frequency conversion components configured to perform frequency conversion between the first logical plane and the physical plane, each frequency conversion component at least includes a local oscillator and a corresponding frequency converter, and the local oscillator corresponds to one of the plurality of first ports corresponding to the first logical plane.

In some example embodiments, the wired communication connection is based on a hybrid fiber coax (HFC) interface between the terminal device and the network device, and/or the terminal device includes CPE.

Example embodiments of the present disclosure also provide a further apparatus for communication.

The means for communicating may include means for performing respective steps of the method 900. The means may be implemented in any suitable manner. For example, the means may be implemented as a circuit device or a software module.

The apparatus for communication may include: means for performing matching between a first communication capability of a terminal device and a second communication capability of the network device, the first communication capability indicating at least one of a first wired communication capability or a first wireless communication capability of the terminal device, and the second communication capability indicating at least one of a second wired communication capability or a second wireless communication capability of the network device; means for receiving, from the terminal device, a matching result for the first communication capability and the second communication capability, the matching result indicating whether the first communication capability successfully matches or fails to match the second communication capability; means for transmitting, to the terminal device, configuration information for a wired communication connection between the terminal device and the network device based on the matching result indicating that the first communication capability successfully matches the second communication capability; and means for performing communication with the terminal device via the wired communication connection based on the configuration information.

In some example embodiments, the means for communicating may include means for transmitting network capability information to the terminal device, the network capability information indicating the second communication capability of the network device.

In some example embodiments, the apparatus for communicating may further include: in response to determining that the matching result indicates that the first communication capability successfully matches the second communication capability, receiving terminal capability information from the terminal device, where the terminal capability information indicates the first communication capability of the terminal device. The configuration information is included in a response of the network device to the terminal capability information.

In some example embodiments, the configuration information at least includes: a configuration for characterizing a physical plane of the wired communication connection between the terminal device and the network device, a configuration of a first logical plane in the terminal device, the first logical plane being configured to connect the physical plane and a component in the terminal device supporting the first wireless communications capability, and a configuration of a second logical plane in the network device, the second logical plane being configured to connect the physical plane and a component in the network device supporting the second wireless communications capability.

In some example embodiments, the configuration information at least includes a configuration of a second analog front end (AFE) interfaced with the wired communication connection, where the second AFE is configured to perform conversion of spatial division multiple access communication on a plurality of second ports corresponding to the second logical plane into frequency division multiple access communication corresponding to the physical plane.

In some example embodiments, the first communication capability indicates at least one of a frequency range and a signal bandwidth for a time division duplex (TDD) communication in the first wireless communication capability of the terminal device, a first logical frequency range and a signal bandwidth for the first wireless communication capability supported by the first logical plane, a frequency range and a signal bandwidth of the at least one transmit port at the first logical plane, a frequency range and a signal bandwidth of the at least one receive port at the first logical plane, a number of transmit antennas at the first logical plane, a number of receive antennas at the first logical plane, ARFCN information at the physical plane.

In some example embodiments, the second communication capability indicates at least one of a frequency range and a signal bandwidth for time division duplex communication in the second wireless communication capability of the network device, a second logical frequency range and signal bandwidth for the second wireless communication capability supported by the second logical plane, a frequency range and a signal bandwidth of the at least one transmit port at the second logical plane, a frequency range and a signal bandwidth of the at least one receive port at the second logical plane, a number of transmit antennas at the second logical plane, a number of receive antennas at the second logical plane, a number of DUs at the second logical plane, and ARFCN information at the physical plane.

In some example embodiments, the network device further includes an inverse analog front end and a corresponding mirror logical plane, and the apparatus for communicating further includes: the means for obtaining a calibration parameter of the inverse analog front end, the calibration parameter being associated with a calibration frequency corresponding to the mirror logical plane; the means for measuring signal related information at the mirror logical plane, the signal related information being associated with the calibration frequency; and the means for obtaining signal information corresponding to the physical plane based on the calibration parameter and the signal related information.

In some example embodiments, the wired communication connection is based on a hybrid fiber coax (HFC) interface between the terminal device and the network device, and/or the terminal device includes CPE.

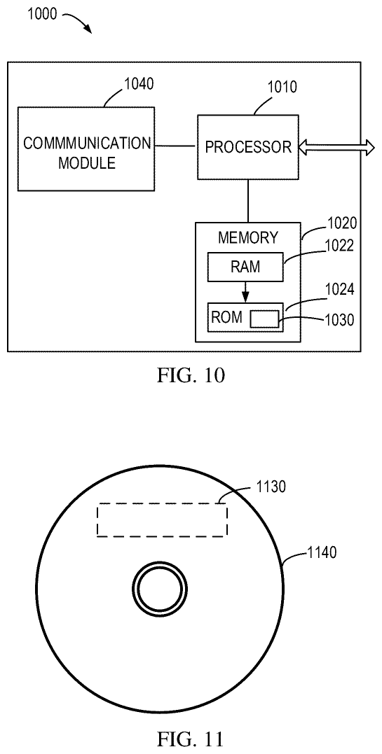

FIG. 10 is a simplified block diagram of a device 1000 suitable for implementing example embodiments of the present disclosure. The device 1000 may be configured to implement the terminal device 110 and/or the network device 120 in the communications network 100. As shown, the device 1000 includes one or more processing units 1010, one or more memories 1020 coupled to the processing unit 1010, and a communication module 1040 coupled to the processing unit 1010.

The communication module 1040 is for bi-directional communication. In some example embodiments, the communication module 1040 may have at least one antenna to facilitate communication. In some example embodiments, the communication module 1040 may include one or more communication interfaces. The communication interface may represent any interface required to communicate with other network elements.

The processing unit 1010 may be of any type suitable for a local technology network and may include, but is not limited to, one or more of a general purpose computer, a special purpose computer, a microcontroller, a digital signal controller (DSP), and a controller-based multi-core controller architecture. The device 1000 may have multiple processors, such as an application specific integrated circuit chip, that temporally Slave a clock that is synchronized with the main processor.

The memory 1020 may include one or more non-volatile memory and one or more volatile memories.

Examples of non-volatile memory include, but are not limited to, read-only memory (ROM) 1024, erasable programmable read-only memory (EPROM), flash memory, hard disk, compact disc (CD), digital video disc (DVD), and other magnetic storage and/or optical storage. Examples of volatile memory include, but are not limited to, random access memory (RAM) 1022 and other volatile memory that does not persist in the power-off duration.

Computer program 1030 includes computer-executable instructions executed by associated processing unit 1010. Computer program 1030 may be stored in ROM 1024. Processing unit 1010 may perform any suitable action and processing by loading computer program 1030 into RAM 1022.

Example embodiments of the present disclosure may be implemented byway of computer program 1030, such that device 1000 may perform any of the processes of the present disclosure as discussed with reference to FIGS. 2-9. Example embodiments of the present disclosure may also be implemented by hardware or by a combination of software and hardware.

In some example embodiments, the computer program 1030 may be tangibly embodied in a computer-readable medium, which may be included in the device 1000, such as in the memory 1020, or other storage device that may be accessed by the device 1000. The computer program 1030 may be loaded from a computer-readable medium to the RAM 1022 for execution. The computer-readable medium may include any type of tangible non-volatile memory, such as ROM, EPROM, flash memory, hard disk, CD, DVD, or the like. FIG. 11 illustrates an example of a computer-readable medium 1100 in the form of a CD or DVD according to some example embodiments of the present disclosure. Computer readable medium 1100 has stored thereon a computer program 1030.

In general, various embodiments of the present disclosure may be implemented in hardware or dedicated circuitry, software, logic, or any combination thereof. Some aspects may be implemented in hardware, while other aspects may be implemented in firmware or software, which may be executed by a controller, microprocessor, or other computing device. Although various aspects of example embodiments of the present disclosure are shown and described as block diagrams, flowcharts, or using some other diagrammatic representation, it should be understood that the blocks, apparatuses, systems, techniques, or methods described herein may be implemented as, for example, non-limiting examples, hardware, software, firmware, dedicated circuits or logic, general purpose hardware or controllers, or other computing devices, or some combination thereof.

The present disclosure also provides at least one computer program product tangibly stored on a computer-readable storage medium. In some example embodiments, the computer-readable storage medium may be non-transitory. The computer program product includes computer-executable instructions, such as instructions included in a program module, that execute in a device on a real or virtual processor of a target to perform method 800 as described above with reference to FIG. 8 or method 900 of FIG. 9. Generally, program modules include routines, programs, libraries, objects, classes, components, data structures, etc. that perform particular tasks or implement particular abstract data types. In various embodiments, the functionality of program modules may be combined or segmented between program modules as desired. Machine executable instructions for program modules may be executed within a local or distributed device. In distributed devices, program modules may be located in local and remote storage media.

Computer program code for implementing the methods of the present disclosure may be written in one or more programming languages. These computer program code may be provided to a processor of a general purpose computer, special purpose computer, or other programmable data processing apparatus, such that the program code, when executed by a computer or other programmable data processing apparatus, causes the functions/operations specified in the flowchart and/or block diagram to be implemented. The program code may be entirely on a computer, partly on a computer, as a stand-alone software package, partly on a computer and partly on a remote computer or entirely on a remote computer or server.

In the context of the present disclosure, computer program code or related data may be carried by any suitable carrier to enable a device, apparatus, or processor to perform the various processes and operations described above. Examples of carriers include signals, computer-readable media, and the like. Examples of signals may include electrical, optical, radio, sound, or other forms of propagating signals, such as carriers, infrared signals, and the like.

The computer-readable medium may be any tangible medium containing or storing a program for or with respect to an instruction execution system, apparatus, or device. The computer readable medium may be a computer readable signal medium or a computer readable storage medium. Computer-readable media may include, but are not limited to, electronic, magnetic, optical, electromagnetic, infrared, or semiconductor systems, devices, or devices, or any suitable combination thereof. A more detailed example of a computer-readable storage medium includes an electrical connection with one or more wires, a portable computer diskette, a hard disk, a random access memory (RAM), a read-only memory (ROM), an erasable programmable read-only memory (EPROM or Flash memory), an optical storage device, a magnetic storage device, or any suitable combination thereof.

Moreover, although the operations of the methods of the present disclosure are described in a particular order in the figures, this is not a requirement or implying that the operations must be performed in that particular order, or that all of the illustrated operations must be performed to achieve the desired results. Rather, the steps depicted in the flowchart may change the order of execution. Additionally, or alternatively, certain steps may be omitted, combining multiple steps into one step, and/or decomposing one step into multiple steps. It should also be noted that the features and functions of two or more devices according to the present disclosure may be embodied in one device. Conversely, the features and functions of one of the devices described above may be further divided into being embodied by multiple devices.

While the present disclosure has been described with reference to several specific embodiments, it should be understood that the present disclosure is not limited to the specific embodiments disclosed. The present disclosure is intended to cover various modifications and equivalent arrangements included within the spirit and scope of the appended claims.

1. A terminal device comprising:
at least one processor; and
at least one memory coupled to the at least one processor, the at least one memory having instructions stored thereon, the at least one memory and the instructions being configured, with the at least one processor, to cause the terminal device to:
perform matching between a first communication capability of the terminal device and a second communication capability of a network device, the first communication capability indicating at least one of a first wired communication capability or a first wireless communication capability of the terminal device, and the second communication capability indicating at least one of a second wired communication capability or a second wireless communication capability of the network device;
transmit a matching result for the first communication capability and the second communication capability to the network device, the matching result indicating whether the first communication capability successfully matches or fails to match the second communication capability;
receive, from the network device, configuration information for a wired communication connection between the terminal device and the network device based on the matching result indicating that the first communication capability successfully matches the second communication capability; and
perform communication with the network device via the wired communication connection based on the configuration information.

2. The terminal device of claim 1, wherein the at least one memory and the instructions is configured, with the at least one processor, to cause the terminal device to:
receive network capability information from the network device, the network capability information indicating the second communication capability of the network device.

3. The terminal device of claim 1, wherein the at least one memory and the instructions is further configured, with the at least one processor, to cause the terminal device to:
based on the matching result indicating that the first communication capability successfully matches the second communication capability, transmit terminal capability information to the network device, the terminal capability information indicating the first communication capability of the terminal device,
wherein the configuration information is comprised in a response of the network device to the terminal capability information.

4. The terminal device of claim 1, wherein the configuration information at least comprises:
a configuration for characterizing a physical plane of the wired communication connection between the terminal device and the network device,
a configuration of a first logical plane in the terminal device, the first logical plane being configured to connect the physical plane and a component in the terminal device supporting the first wireless communications capability, and
a configuration of a second logical plane in the network device, the second logical plane being configured to connect the physical plane and a component in the network device supporting the second wireless communications capability.

5. The terminal device of claim 4, wherein the configuration information at least comprises:
a configuration of a first analogue front end, AFE, interfaced with the wired communication connection, the first AFE being configured to perform conversion of spatial division multiple access communication on a plurality of first ports corresponding to the first logical plane into frequency division multiple access communication corresponding to the physical plane.

6. The terminal device of claim 4, wherein the first communication capability indicates at least one of the following:
a frequency range and a signal bandwidth for time division duplex, TDD, communication in the first wireless communication capability of the terminal device,
a first logical frequency range and a signal bandwidth for the first wireless communication capability supported by the first logical plane,
a frequency range and a signal bandwidth of at least one transmit port at the first logical plane,
a frequency range and a signal bandwidth of at least one receive port at the first logical plane,
a number of transmit antennas at the first logical plane,
a number of receive antennas at the first logical plane, or
absolute radio frequency channel number, ARFCN, information at the physical plane.

7. The terminal device of claim 4, wherein the second communication capability indicates at least one of the following:
a frequency range and a signal bandwidth for TDD communication in the second wireless communication capability of the network device,
a second logical frequency range and a signal bandwidth for the second wireless communication capability supported by the second logical plane,
a frequency range and a signal bandwidth of at least one transmit port at the second logical plane,
a frequency range and a signal bandwidth of at least one receive port at the second logical plane,
a number of transmit antennas at the second logical plane,
a number of receive antennas at the second logical plane,
a number of distributed units, DUs, at the second logical plane,
absolute radio frequency channel number information at the physical plane.

8. The terminal device of claim 1, wherein the wired communication connection is based on a hybrid fiber coax, HFC, interface between the terminal device and the network device, and/or
wherein the terminal device comprises customer premises equipment, CPE.

9. A network device comprising:
at least one processor; and
at least one memory coupled with the at least one processor, the at least one memory having instructions stored thereon, the at least one memory and the instructions being configured, with the at least one processor, to cause the network device to:
perform matching between a first communication capability of a terminal device and a second communication capability of the network device, the first communication capability indicating at least one of a first wired communication capability or a first wireless communication capability of the terminal device, and the second communication capability indicating at least one of a second wired communication capability or a second wireless communication capability of the network device;
receive, from the terminal device, a matching result for the first communication capability and the second communication capability, the matching result indicating whether the first communication capability successfully matches or fails to match the second communication capability;
transmit, to the terminal device, configuration information for a wired communication connection between the terminal device and the network device based on the matching result indicating that the first communication capability successfully matches the second communication capability; and
perform communication with the terminal device via the wired communication connection based on the configuration information.

10. The network device of claim 9, wherein the at least one memory and the instructions is configured, with the at least one processor, to cause the network device to:
transmit network capability information to the terminal device, the network capability information indicating the second communication capability of the network device.

11. The network device of claim 9, wherein the at least one memory and the instructions is further configured, with the at least one processor, to cause the network device to:
in response to determining that the matching result indicates that the first communication capability successfully matches the second communication capability, receive terminal capability information from the terminal device, the terminal capability information indicating the first communication capability of the terminal device,
wherein the configuration information is comprised in a response of the network device to the terminal capability information.

12. The network device of claim 9, wherein the configuration information comprising at least:
a configuration for characterizing a physical plane of the wired communication connection between the terminal device and the network device,
a configuration of a first logical plane in the terminal device, the first logical plane being configured to connect the physical plane and a component in the terminal device supporting the first wireless communications capability, and
a configuration of a second logical plane in the network device, the second logical plane being configured to connect the physical plane and a component in the network device supporting the second wireless communications capability.

13. The network device of claim 12, wherein the configuration information at least comprises:
a configuration of a second analog front end, AFE, interfaced with the wired communication connection, the second AFE being configured to perform conversion of spatial division multiple access communication on a plurality of second ports corresponding to the second logical plane into frequency division multiple access communication corresponding to the physical plane.

14. The network device of claim 12, wherein the first communication capability indicates at least one of the following:
a frequency range and a signal bandwidth for time division duplex, TDD, communication in the first wireless communication capability of the terminal device,
a first logical frequency range and a signal bandwidth for the first wireless communication capability supported by the first logical plane,
a frequency range and a signal bandwidth of at least one transmit port at the first logical plane,
a frequency range and a signal bandwidth of at least one receive port at the first logical plane,
a number of transmit antennas at the first logical plane,
a number of receive antennas at the first logical plane,
absolute radio frequency channel number, ARFCN, information at the physical plane.

15. The network device of claim 12, wherein the second communication capability indicates at least one of the following:
a frequency range and a signal bandwidth for TDD communication in the second wireless communication capability of the network device,
a second logical frequency range and a signal bandwidth for the second wireless communication capability supported by the second logical plane,
a frequency range and a signal bandwidth of at least one transmit port at the second logical plane,
a frequency range and a signal bandwidth of at least one receive port at the second logical plane,
a number of transmit antennas at the second logical plane,
a number of receive antennas at the second logical plane,
a number of distributed units, DUs, at the second logical plane, or
absolute radio frequency channel number information at the physical plane.

16. The network device of claim 9, wherein the network device further comprises an inverse analog front end and a corresponding mirror logical plane, the at least one memory and the instructions being further configured, with the at least one processor, to cause the network device to:
obtain a calibration parameter of the inverse analog front end, the calibration parameter being associated with a calibration frequency corresponding to the mirror logical plane;
measure signal related information at the mirror logical plane, the signal related information being associated with the calibration frequency; and
obtain signal information corresponding to the physical plane based on the calibration parameter and the signal related information.

17. The network device of claim 9, wherein the wired communication connection is based on a hybrid fiber coax, HFC, interface between the terminal device and the network device, and/or
wherein the terminal device includes customer premises equipment, CPE.

18. A terminal device connected to a network device through a physical transmission medium, the terminal device comprising:
a first logical plane configured to connect between a physical plane and a component in the terminal device supporting a first wireless communication capability, the physical plane being configured to characterize a wired communication connection based on the physical transmission medium between the terminal device and the network device;
a first analog front end, AFE, connected to the first logical plane and the physical transmission medium, respectively; and
a controller configured to control the terminal device to perform wired communication with the network device via the physical transmission medium based on configuration information for the wired communication connection.

19. The terminal device of claim 18, wherein the controller is further configured to:
control the first AFE to convert spatial division multiple access communication on a plurality of first ports corresponding to the first logical plane into frequency division multiple access communication corresponding to the physical plane, to enable the terminal device to perform communication with the network device via the physical transmission medium.

20. The terminal device of claim 18, wherein the first AFE comprises a band group selector configured to select, from a plurality of absolute radio frequency channel number, ARFCN, groups at the physical plane, a target ARFCN group for allocation to uplink and downlink communications between the terminal device and the network device.

21-29. (canceled)
